(19) United States
(12) Patent Application Publication
(10) Pub. No.: US 2025/0058562 A1
(43) Pub. Date: Feb. 20, 2025

(54) PRINTING CONTROL DEVICE, PRINTING CONTROL METHOD, PROGRAM, AND PRINTING SYSTEM

(71) Applicant: FUJIFILM Corporation, Tokyo (JP)

(72) Inventor: Hayate NAKAMURA, Kanagawa (JP)

(73) Assignee: FUJIFILM Corporation, Tokyo (JP)

(21) Appl. No.: 18/938,261

(22) Filed: Nov. 5, 2024

Related U.S. Application Data
(63) Continuation of application No. PCT/JP2023/015135, filed on Apr. 14, 2023.

(30) Foreign Application Priority Data
May 10, 2022 (JP) 2022-077617

(51) Int. Cl. B41J 2/045; B41J 2/165; B41J 2/21

(52) U.S. Cl. CPC B41J 2/04588; B41J 2/04551; B41J 2/16579; B41J 2/2114; B41J 2/04581

(57) ABSTRACT

A printing control device determines whether a first printing mode in which a pretreatment liquid that reacts with a liquid jetted from an ink jet head to relatively increase a viscosity of a liquid is applied to a medium or a second printing mode in which the pretreatment liquid is not applied to the medium is set; sets a first driving waveform as a driving waveform of the ink jet head in a case of the first printing mode, and sets a second driving waveform as the driving waveform of the ink jet head in a case of the second printing mode is set; and reduces a maximum liquid jetting amount to be jetted from one nozzle in one jetting period in a case where the second driving waveform is applied as compared with a case where the first driving waveform is applied.

### CROSS-REFERENCE TO RELATED APPLICATIONS

The present application is a Continuation of PCT International Application No. PCT/JP2023/015135 filed on Apr. 14, 2023 claiming priority under 35 U.S.C § 119(a) to Japanese Patent Application No. 2022-077617 filed on May 10, 2022. Each of the above applications is hereby expressly incorporated by reference, in its entirety, into the present application.

### BACKGROUND OF THE INVENTION

### 1. Field of the Invention

The present invention relates to a printing control device, a printing control method, a program, and a printing system.

### 2. Description of the Related Art

As an ink used in an ink jet printing device, a two-component ink in which a pretreatment liquid is applied before executing formation of an image is known. In addition, as an ink used in the ink jet printing device, a one-component ink in which a pretreatment liquid is not applied before executing formation of an image is known.

In printing using the two-component ink, the ink jetted from an ink jet head reacts with the pretreatment liquid, and the flow of the ink on the paper is suppressed, so that drying unevenness of the paper on which the image is printed is suppressed. Meanwhile, in the printing using the two-component ink, since the pretreatment liquid is used, a volume of the liquid applied on the paper is increased, and energy required for a drying treatment is increased as compared with a case where the one-component ink is used.

In the printing using the two-component ink, a paper deformation such as cockling due to a lack of the energy required for the drying treatment is relatively large, which may lead to an occurrence of paper floating during back printing in double-sided printing.

In the printing using the one-component ink, a quality of a printed image is inferior to that in a case where the two-component ink is used, but the energy required for the drying treatment is smaller than that in a case where a two-component ink is used, so that the paper deformation is smaller, and transportability of the paper is excellent.

JP2021-054623A discloses an ink jet printing device comprising a pretreatment unit that applies a pretreatment liquid to a sheet material. In the device described in JP2021-054623A, a relationship between a type of the sheet material, information on a basis weight or a thickness, and a wind volume of an air blower is tabled and stored, including a relationship with the presence or absence of the application of the treatment liquid. In this device, the presence or absence of the application of the treatment liquid is discriminated, and in a case where the treatment liquid is not applied, it is discriminated whether or not the sheet material is a thin coated paper.

In this device, in a case where the sheet material is a thin coated paper, the air volume of the air blower is increased, and in a case where the treatment liquid is applied or the sheet material is not a thin coated paper, the air volume of the air blower is decreased.

### SUMMARY OF THE INVENTION

However, there are merits and demerits in each of a case where the one-component ink is used and a case where the two-component ink is used. It is preferable that, in one printing device, a mode in which the one-component ink is used and a mode in which the two-component ink is used can be selected according to the application. It is preferable to set an optimal process according to each mode for implementing a high level of selection between both modes.

Since the one-component ink and the two-component ink have different wetting spread rates, it is preferable to adopt an aspect of switching to an optimal jetting waveform in which an ink jetting amount for one dot can be changed according to whether the ink being used is the one-component ink or the two-component ink.

In JP2021-054623A, the air volume of the air blower is switched depending on the presence or absence of the application of the treatment liquid, but optimization of the ink jetting amount depending on a case where the treatment liquid is applied and a case where the treatment liquid is not applied is not made.

The present invention has been made in view of such circumstances, and an object of the present invention is to provide a printing control device, a printing control method, a program, and a printing system in which, for each of a case where a pretreatment liquid is applied and a case where the pretreatment liquid is not applied, optimization of a jetting amount of a liquid jetted from each nozzle in one jetting period is realized.

According to an aspect of the present disclosure, there is provided a printing control device that controls a printing device including an ink jet head provided with one or more nozzles, the printing control device comprising: one or more processors; and one or more memories in which a program to be executed by the one or more processors is stored, in which the one or more processors execute the program to: determine whether a first printing mode in which a pretreatment liquid that reacts with a liquid jetted from the ink jet head to relatively increase a viscosity of the liquid is applied to a medium or a second printing mode in which the pretreatment liquid is not applied to the medium is set; set a first driving waveform as a driving waveform to be applied to the ink jet head in a case where it is determined that the first printing mode is set, and set a second driving waveform as the driving waveform to be applied to the ink jet head in a case where it is determined that the second printing mode is set; and reduce a maximum liquid jetting amount to be jetted from one nozzle in one jetting period in a case where the second driving waveform is applied as compared with a case where the first driving waveform is applied.

With the printing control device according to the aspect of the present disclosure, for each of the first printing mode in which the pretreatment liquid is applied and the second printing mode in which the pretreatment liquid is not applied, optimization of the jetting amount of the liquid to be jetted from each nozzle in one jetting period is realized.

The nozzle includes a nozzle opening for jetting the liquid. The nozzle may include a flow channel that communicates with the nozzle opening and a pressure generation element.

The liquid includes a color ink containing a coloring material, a colorant, and the like. A first ink having a property of being thickened by reacting with the pretreatment liquid can be applied to the first printing mode. A second ink containing no component that reacts with the pretreatment liquid can be applied to the second printing mode.

In the printing control device according to another aspect, the second driving waveform may have a smaller amplitude than the first driving waveform.

According to this aspect, in a case where the second driving waveform is applied, the jetting amount of the liquid to be jetted from one nozzle in one jetting period can be reduced as compared with a case where the first driving waveform is applied.

In the printing control device according to still another aspect, each of the first driving waveform and the second driving waveform may include a plurality of pulse waveforms, and the second driving waveform may include a smaller number of pulse waveforms than the first driving waveform.

According to this aspect, in a case where the second driving waveform is applied, the jetting amount of the liquid to be jetted from one nozzle in one jetting period can be reduced as compared with a case where the first driving waveform is applied.

In the printing control device according to still another aspect, the second driving waveform may have a smaller amplitude change per unit time than the first driving waveform.

According to this aspect, in a case where the second driving waveform is applied, the jetting amount of the liquid to be jetted from one nozzle in one jetting period can be reduced as compared with a case where the first driving waveform is applied.

In the printing control device according to still another aspect, the one or more processors may apply the second printing mode in a case of applying the liquid to both sides of one surface and the other surface of the medium, and may apply the first printing mode in a case of applying the liquid to only one surface of the medium.

According to this aspect, in the second printing mode in which the pretreatment liquid is not applied, the liquid on the medium is likely to wet and spread, and dots having a prescribed size can be formed by using a relatively small amount of the liquid as compared with the first printing mode in which the pretreatment liquid is applied.

In the printing control device according to still another aspect, in a case of controlling a drying device that is provided in the printing device and that performs a drying treatment on the medium to which the liquid jetted from the ink jet head is applied, the one or more processors may apply a first drying strength as a drying strength in a case where it is determined that the first printing mode is set, and may apply a second drying strength as a drying strength in a case where it is determined that the second printing mode is set, and the second drying strength may be a drying strength lower than the first drying strength.

According to this aspect, in the second printing mode, deformation of the medium due to the drying treatment is suppressed, and optimization of medium transport is realized.

In the printing control device according to still another aspect, the one or more processors may read out a first drying condition table in which the first drying strength is prescribed in a case where the first printing mode is applied, and may read out a second drying condition table in which the second drying strength is prescribed in a case where the second printing mode is applied.

According to this aspect, the drying strength optimized in advance for each printing mode can be applied to the first printing mode and the second printing mode.

According to still another aspect of the present disclosure, there is provided a printing control method of controlling a printing device including an ink jet head provided with one or more nozzles, the printing control method comprising: determining whether a first printing mode in which a pretreatment liquid that reacts with a liquid jetted from the ink jet head to relatively increase a viscosity of the liquid is applied to a medium or a second printing mode in which the pretreatment liquid is not applied to the medium is set; setting a first driving waveform as a driving waveform to be applied to the ink jet head in a case where it is determined that the first printing mode is set, and setting a second driving waveform as the driving waveform to be applied to the ink jet head in a case where it is determined that the second printing mode is set; and reducing a maximum liquid jetting amount to be jetted from one nozzle in one jetting period in a case where the second driving waveform is applied as compared with a case where the first driving waveform is applied.

With the printing control method according to this aspect of the present disclosure, it is possible to obtain the same operation and effect as those of the printing control device according to the aspect of the present disclosure. Configuration requirements of the printing control device according to the other aspects can be applied to configuration requirements of the printing control method according to other aspects.

According to still another aspect of the present disclosure, there is provided a program for controlling a printing device including an ink jet head provided with one or more nozzles, the program causing a computer to realize: a function of determining whether a first printing mode in which a pretreatment liquid that reacts with a liquid jetted from the ink jet head to relatively increase a viscosity of the liquid is applied to a medium or a second printing mode in which the pretreatment liquid is not applied to the medium is set; and a function of setting a first driving waveform as a driving waveform to be applied to the ink jet head in a case where it is determined that the first printing mode is set, and setting a second driving waveform as the driving waveform to be applied to the ink jet head in a case where it is determined that the second printing mode is set, the program further causing the computer to reduce a maximum liquid jetting amount to be jetted from one nozzle in one jetting period in a case where the second driving waveform is applied as compared with a case where the first driving waveform is applied.

With the program according to this aspect of the present disclosure, it is possible to obtain the same operation effect as those of the printing control device according to the aspect of the present disclosure. Configuration requirements of the printing control device according to the other aspects can be applied to configuration requirements of the program according to other aspects.

According to still another aspect of the present disclosure, there is provided a printing system comprising: an ink jet head provided with one or more nozzles; a pretreatment liquid applying device that applies a pretreatment liquid to a medium; one or more processors; and one or more memories in which a program to be executed by the one or more processors is stored, in which the one or more processors execute the program to: determine whether a first printing mode in which the pretreatment liquid that reacts with a liquid jetted from the ink jet head to relatively increase a viscosity of the liquid is applied to a medium or a second printing mode in which the pretreatment liquid is not applied to the medium is set; set a first driving waveform as a driving waveform to be applied to the ink jet head in a case where it is determined that the first printing mode is set, and set a second driving waveform as the driving waveform to be applied to the ink jet head in a case where it is determined that the second printing mode is set; and reduce a maximum liquid jetting amount to be jetted from one nozzle in one jetting period in a case where the second driving waveform is applied as compared with a case where the first driving waveform is applied.

With the printing system according to this aspect of the present disclosure, it is possible to obtain the same operation and effect as those of the printing control device according to the aspect of the present disclosure. Configuration requirements of the printing control device according to the other aspects can be applied to configuration requirements of the printing system according to other aspects.

According to the present disclosure, for each of the first printing mode in which the pretreatment liquid is applied and the second printing mode in which the pretreatment liquid is not applied, optimization of the jetting amount of the liquid to be jetted from each nozzle in one jetting period is realized.

### BRIEF DESCRIPTION OF THE DRAWINGS

FIG. 1 is a perspective view showing an overall configuration of a printing system according to a first embodiment.

FIG. 2 is a functional block diagram showing an electric configuration of the printing system shown in FIG. 1.

FIG. 3 is a block diagram schematically showing an example of a hardware configuration of the electric configuration shown in FIG. 2.

FIG. 4 is a perspective view showing a configuration example of an ink jet head.

FIG. 5 is a perspective view of a head module and is a view including a partial cross-sectional view.

FIG. 6 is a plan view showing a nozzle disposition example of the ink jet head shown in FIG. 4.

FIG. 7 is a cross-sectional view showing an internal structure of the head module.

FIG. 8 is a flowchart showing a procedure of a printing control method according to the first embodiment.

FIG. 9 is a table showing setting of a parameter for each printing mode applied to the printing system according to the first embodiment.

FIG. 10 is a schematic diagram representing a first driving waveform applied to a first printing mode.

FIG. 11 is a schematic diagram showing a first example of a second driving waveform applied to a second printing mode.

FIG. 12 is a schematic diagram showing a second example of the second driving waveform applied to the second printing mode.

FIG. 13 is a schematic diagram showing a third example of the second driving waveform applied to the second printing mode.

FIG. 14 is a functional block diagram showing an electric configuration of a printing system according to a second embodiment.

FIG. 15 is a block diagram schematically showing an example of a hardware configuration of the electric configuration shown in FIG. 14.

FIG. 16 is a flowchart showing a procedure of a printing control method according to the second embodiment.

FIG. 17 is a table showing setting of a parameter for each printing mode applied to the printing system according to the second embodiment.

### DESCRIPTION OF THE PREFERRED EMBODIMENTS

Hereinafter, preferred embodiments of the present invention will be described with reference to the accompanying drawings. In the present specification, the same components are denoted by the same reference numerals, and duplicate descriptions thereof will be omitted as appropriate.

### [Configuration Example of Printing System According to First Embodiment]

### [Overview of Printing System]

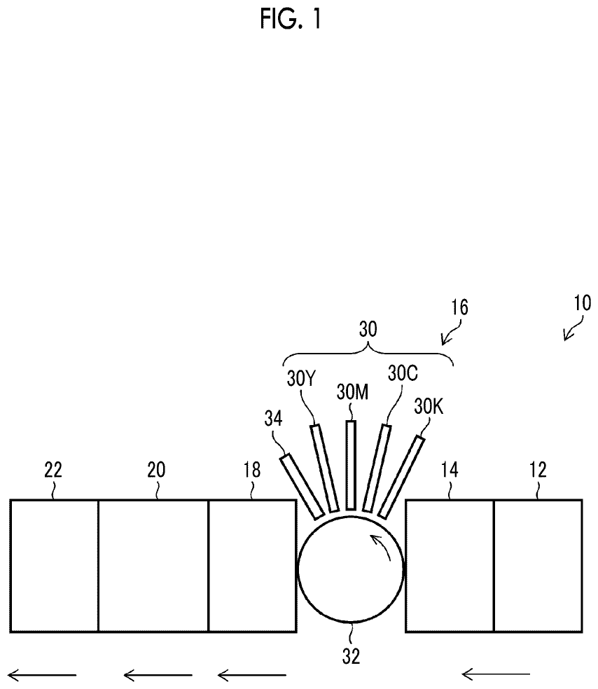

FIG. 1 is a perspective view showing an overall configuration of a printing system according to a first embodiment. The printing system 10 achieves a first printing mode in which an image quality is excellent and a second printing mode in which transportability of paper is excellent by using one printing system. That is, the printing system 10 has the first printing mode that sets importance on a high image quality and the second printing mode that sets importance on transportability of paper, and is configured to be switchable between the first printing mode and the second printing mode. The printing mode can be switched for each printing job.

In the printing system 10, from the viewpoint of setting importance on the transportability of the paper, the first printing mode in which a precoating liquid is used is recommended for single-sided printing in which an image is printed on only one surface of the paper. On the other hand, the second printing mode in which the precoating liquid is not used is recommended for double-sided printing in which an image is printed on both sides of one surface and the other surface of the paper.

In the printing system 10, a driving waveform applied to the first printing mode is different from a driving waveform applied to the second printing mode. Specifically, as the driving waveform applied to the second printing mode, a waveform in which a jetting amount of ink jetted from one nozzle in one jetting period is small as compared with the driving waveform applied to the first printing mode is applied.

The reason is as follows. In the second printing mode, since the precoating liquid is not used, a wetting spread rate of the ink on the paper is large, and it is possible to form an image without pixel missing using a smaller amount of ink as compared with the first printing mode in which the precoating liquid is used.

The comparison between an ink jetting amount applied to the first printing mode and an ink jetting amount applied to the second printing mode may be made between the maximum ink jetting amounts to be jetted from one nozzle in one jetting period. In a case where a plurality of types of liquid droplet sizes, such as large droplets, medium droplets, and small droplets, are used as the ink jetting amount to be jetted from one nozzle in one jetting period, the ink jetting amount is adjusted for each liquid droplet size according to the printing mode. Details of the adjustment of the ink jetting amount will be described below.

The precoating liquid described in the embodiment is an example of a pretreatment liquid. The first printing mode described in the embodiment is an example of a first printing mode in which a pretreatment liquid that reacts with a liquid jetted from an ink jet head to relatively increase a viscosity of the liquid is applied to a medium. The second printing mode described in the embodiment is an example of a second printing mode in which the pretreatment liquid is not applied to the medium. The jetting amount of the large droplets described in the embodiment is an example of the maximum liquid jetting amount to be jetted from one nozzle in one jetting period.

### [Overall Configuration]

The printing system 10 is provided with a printing device 16 of a digital type that prints a color image on the paper by applying single-pass printing.

As the paper, a paper medium such as single-wafer paper and continuous paper, a sheet-like metal medium, a cloth medium such as a cloth, and the like may be applied. As the paper, a soft package such as a plastic film may be applied. The paper may be a single layer or a plurality of layers superimposed on each other. The paper may have a roll-to-roll continuous form or a single-wafer form cut to a prescribed length. The paper will be referred to as a medium, media, a sheet, a film, a substrate, or the like in some cases. The paper is shown.

The printing system 10 comprises a paper feeding device 12, a precoating device 14, a printing device 16, a drying device 18, an inspection device 20, and an accumulation device 22.

The arrow lines shown in FIG. 1 indicate a paper transport direction of each unit in the printing system 10. The paper transport direction is a direction in which the paper moves from the paper feeding device 12 to the accumulation device 22 through the precoating device 14, the printing device 16, the drying device 18, and the inspection device 20.

In addition, a direction perpendicular to the paper transport direction and parallel to a surface parallel to a printing surface of the paper is a paper width direction. Hereinafter, each unit constituting the printing system 10 will be described in detail.

### [Paper Feeding Device]

In a case where the paper has a single-wafer form, the paper feeding device 12 comprises a tray that accommodates the paper. In a case where the paper has a continuous form, the paper feeding device 12 comprises a roll accommodating portion that accommodates a roll around which the paper is wound. The paper feeding device 12 supplies the paper to the precoating device 14 in response to printing control of the printing device 16. The paper feeding device 12 may comprise a correction mechanism that corrects a posture of the paper.

### [Precoating Device]

The precoating device 14 applies a precoating liquid that coagulates or insolubilizes a coloring material component contained in an aqueous ink, to the paper. In the paper transport direction in the printing system 10, the precoating device 14 is disposed at a position on a downstream side of the paper feeding device 12 and on an upstream side of the printing device 16.

The precoating device 14 comprises an application roller, and a roller application type of transferring the precoating liquid applied to a surface of the application roller to the printing surface of the paper by bringing the application roller into contact with the printing surface of the paper is applied.

The precoating device 14 may comprise a metering roller that transfers the measured precoating liquid to the surface of the application roller and a precoating liquid storage unit that stores the precoating liquid. Another application type such as a spray type and an ink jet type may be applied to the precoating device 14.

The precoating liquid contains a coagulating agent as a component for coagulating the coloring material component contained in the aqueous ink. Examples of the coagulating agent include a polyvalent metal compound, an organic acid, a metal complex, and an aqueous cationic polymer. The coagulating agent may contain an organic acid.

From the viewpoint of a coagulation rate of the ink, the content of the coagulating agent with respect to a total amount of the precoating liquid is preferably 0.1% by mass or more and 40% by mass or less, and more preferably 1% by mass or more and 10% by mass or less.

The precoating liquid is preferably in a form containing water. The content of water with respect to the total amount of the precoating liquid is preferably 50% by mass or more and more preferably 60% by mass or more. An upper limit of the content of water with respect to the total amount of the precoating liquid is preferably 90% by mass and more preferably 80% by mass.

The precoating liquid can contain resin particles, a water-soluble solvent, and a surfactant. The precoating liquid may contain a solid wetting agent, colloidal silica, an inorganic salt, a fading inhibitor, an emulsion stabilizer, a penetration enhancer, an ultraviolet absorber, a preservative, a fungicide, a pH adjuster, a viscosity adjuster, a rust inhibitor, a chelating agent, and a water-soluble polymer compound other than the water-soluble cationic polymer.

From the viewpoint of the coagulation rate of the ink, a pH value of the precoating liquid at 25° C. is preferably 0.1 or more and less than 3.5. In addition, from the viewpoint of the coagulation rate of the ink, the viscosity of the precoating liquid in a case of containing the coagulating agent is preferably 0.5 mPa·s or more and 10 mPa·s or less, and more preferably 1 mPa·s or more and 5 mPa·s or less.

A surface tension of the precoating liquid at 25° C. is preferably 60 mN/m or less, and more preferably 20 mN/m or more and 50 mN/m or less. The surface tension of the precoating liquid at 25° C. is further preferably 3 mN/m or more and 45 mN/m or less.

The printing system 10 may comprise a precoating drying device that dries the precoating liquid applied to the printing surface of the paper. The precoating drying device may be configured integrally with the precoating device 14, or may be configured as an external device of the precoating device 14.

The precoating drying device may heat the paper by using a heater or the like, may blow a gas to the paper by using a fan motor or the like, or may blow a heated gas to the paper by using heating and blowing.

The precoating device 14 comprises a precoating transport device that transports the paper in the precoating device 14. A transport type such as roller transport, drum transport, and belt transport can be applied to the precoating transport device. The precoating transport device is not shown. The paper on which the precoating liquid has been applied to the printing surface by the precoating device 14 is sent to the printing device 16. The precoating device 14 described in the embodiment is an example of a pretreatment liquid applying device that applies a pretreatment liquid to a medium.

### [Printing Device]

The printing device 16 comprises an ink jet head 30K, an ink jet head 30C, an ink jet head 30M, and an ink jet head 30Y. The ink jet head 30K, the ink jet head 30C, the ink jet head 30M, and the ink jet head 30Y are disposed in the order described above from an upstream side along the paper transport direction in the printing device 16. An arrow line attached to a printing drum 32 indicates a paper transport direction in the printing device 16.

The ink jet head 30K jets black ink. The ink jet head 30C jets cyan ink. The ink jet head 30M jets magenta ink. The ink jet head 30Y jets yellow ink.

The printing device 16 forms a color image on the paper using color ink such as black ink. The printing device 16 may comprise an ink jet head that jets special color ink other than process ink, such as black, such as an ink jet head that forms a white image as a background image of a color image by using white ink.

Each of the ink jet head 30K, the ink jet head 30C, the ink jet head 30M, and the ink jet head 30Y is applied with a posture in which a normal line of a nozzle surface intersects a vertical direction. Hereinafter, the ink jet head 30K and the like may be referred to as an ink jet head 30 in a case where it is not necessary to distinguish between them.

The printing device 16 comprises the printing drum 32 as a paper transport device in the printing device 16. The printing drum 32 has a cylindrical shape, and is supported to be rotatable with a central axis as a rotation axis. The printing drum 32 comprises a paper support region for supporting the paper on a peripheral surface.

A rotation shaft of the printing drum 32 is connected to a motor serving as a driving source of a drive mechanism via the drive mechanism. In a case where the motor is rotated, the printing drum 32 rotates in a direction indicated by an arrow line. In a case where the printing drum 32 is rotated, the paper supported on the peripheral surface of the printing drum 32 is transported along a rotation direction of the printing drum 32.

A plurality of suction holes are formed in the paper support region. The plurality of suction holes are disposed based on a prescribed pattern. The plurality of suction holes communicate with a gas flow channel. The gas flow channel is connected to a suction pump. The paper is fixed to the paper support region of the printing drum 32 using a negative pressure generated in the plurality of suction holes by operating the suction pump.

A transport form of the paper in the printing device 16 is not limited to a transport form using the printing drum 32. For example, a transport form using a transport belt and a transport form using a plurality of rollers can be applied.

The rotation shaft of the printing drum 32, the drive mechanism of the printing drum 32, the motor connected to the drive mechanism, the paper support region of the printing drum 32, the suction hole of the paper support region, the gas flow channel, and the suction pump are not shown.

The printing device 16 comprises an in-line sensor 34. The in-line sensor 34 is disposed at a position on a downstream side of the ink jet head 30Y in the paper transport direction of the printing device 16. The in-line sensor 34 reads a test pattern printed on the paper and outputs a read signal of the test pattern. The printing device 16 detects an abnormality of the nozzle provided in the ink jet head 30 and the like based on the read signal of the test pattern.

The in-line sensor 34 comprises an image sensor that reads the image printed on the paper. As the image sensor, a CCD image sensor, a CMOS image sensor, and the like can be applied. The in-line sensor 34 has an imaging region corresponding to an entire width of the paper in the paper width direction. The in-line sensor 34 may be provided with an optical member such as a condenser lens. The CCD is an abbreviation for a charge coupled device. The CMOS is an abbreviation for a complementary metal oxide semiconductor.

### [Drying Device]

The drying device 18 performs a drying treatment on the paper delivered from the printing drum 32, which is the paper on which the color image is printed on the printing surface by using the printing device 16. The drying device 18 comprises a heater and a fan, and may adopt a configuration in which hot air is blown onto the printed paper. The drying device 18 comprises a drying transport device that transports the paper in the drying device 18.

As a transport form of the paper applied to the drying transport device, a transport form such as roller transport, drum transport, gripper transport, and belt transport can be applied. A plurality of transport forms may be combined for the drying transport device. For example, the drying transport device can adopt a transport form in which the gripper transport and the belt transport are combined to support a leading end of the paper by using a gripper and support a trailing end of the paper by using a suction belt. The arrow line shown in the drying device 18 indicates a paper transport direction in the drying device 18.

### [Inspection Device]

The inspection device 20 comprises an imaging device that captures a printed image printed on the paper and an illumination device that illuminates the printed image. The inspection device 20 outputs read data of the printed image. The inspection device 20 may detect a defect in the printed image based on the read data of the printed image. The arrow line shown in the inspection device 20 indicates a paper transport direction in the inspection device 20.

The inspection device 20 comprises an inspection transport device that transports the paper in the inspection device 20. As a configuration of the inspection transport device, the same configuration as the configuration of the drying transport device can be applied. The arrow line shown in the inspection device 20 indicates a paper transport direction in the inspection device 20.

### [Accumulation Device]

The accumulation device 22 accommodates the paper delivered from the inspection device 20. In a case where the paper has a single-wafer form, the accumulation device 22 comprises a tray that accommodates the paper. In a case where the paper has a continuous form, the accumulation device 22 includes a roll accommodating portion that accommodates a roll around which the paper is wound.

The accumulation device 22 may sort and store the paper, which is a printed matter, in accordance with an inspection result of the inspection device 20. For example, the accumulation device 22 may comprise a good quality image accommodating portion in which a good quality image is accommodated and a poor quality image accommodating portion in which a poor quality image is accommodated.

The printing system 10 may comprise a maintenance device that executes maintenance processing such as wiping, purging, and suction of the ink jet head 30. The maintenance device may comprise a head moving device that moves the ink jet head 30, a wiping device that performs wiping of the ink jet head 30, and a capping device that caps the ink jet head 30. The maintenance device is not shown.

### [Electric Configuration of Printing System]

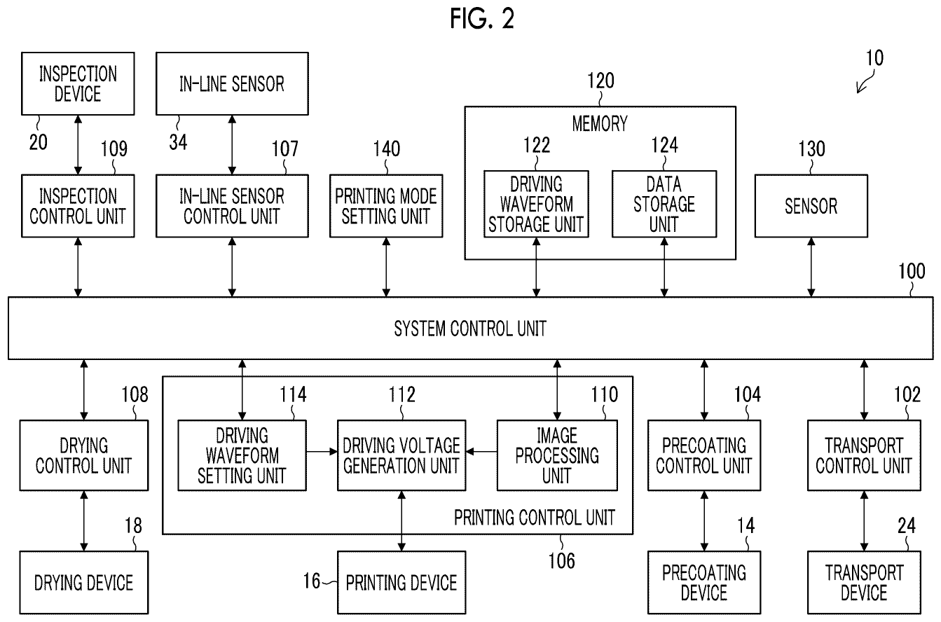

FIG. 2 is a functional block diagram showing an electric configuration of the printing system shown in FIG. 1. The printing system 10 comprises a system control unit 100, a transport control unit 102, a precoating control unit 104, a printing control unit 106, an in-line sensor control unit 107, a drying control unit 108, and an inspection control unit 109. The printing system 10 comprises a memory 120 and a sensor 130.

The system control unit 100 comprehensively controls an overall operation of the printing system 10. The system control unit 100 transmits command signals to various control units. The system control unit 100 functions as a memory controller that controls storage of data in the memory 120 and readout of data from the memory 120.

The memory 120 comprises a driving waveform storage unit 122 and a data storage unit 124. The driving waveform storage unit 122 stores a driving waveform applied to a driving voltage supplied to the ink jet head 30.

The data storage unit 124 stores various types of data applied to the printing system 10. The memory 120 may include a program storage unit in which various programs applied to the printing system 10 are stored, and a parameter storage unit in which various parameters applied to the printing system 10 are stored.

The system control unit 100 acquires a sensor signal transmitted from a sensor 130 and transmits the command signals based on the sensor signal to various control units. The sensor 130 includes a position detection sensor, a temperature sensor, and the like provided in each unit of the printing system 10.

The printing system 10 comprises a printing mode setting unit 140. The printing mode setting unit 140 executes switching between the first printing mode in which the precoating liquid is used and the second printing mode in which the precoating liquid is not used.

In addition, the printing mode setting unit 140 executes switching between a single-sided printing mode in which printing is performed on only one surface of the paper and a double-sided printing mode in which printing is performed on both sides of one surface and the other surface of the paper.

That is, the system control unit 100 transmits the command signal to each unit according to the printing mode set by using the printing mode setting unit 140. For example, in a case where the first printing mode in which the precoating liquid is used is set, the system control unit 100 transmits an operation command signal to the precoating control unit 104. Details of the control of each unit for each printing mode will be described below.

The transport control unit 102 sets a transport condition based on the command signal transmitted from the system control unit 100 and controls an operation of the transport device 24 based on the set transport condition. The transport condition includes a transport speed of the paper.

The transport device 24 shown in FIG. 2 includes the precoating transport device provided in the precoating device 14 shown in FIG. 1, the printing drum 32, the drying transport device provided in the drying device 18, and the inspection transport device provided in the inspection device 20. The transport device 24 may include the paper feeding device 12 and the accumulation device 22.

The precoating control unit 104 sets a precoating condition based on a command signal transmitted from the system control unit 100, and controls an operation of the precoating device 14 based on the set precoating condition. Examples of precoating conditions include an applied amount of the precoating liquid per unit area of the paper and an applied amount of the precoating liquid per unit time.

The precoating control unit 104 operates the precoating device 14 in a case where the first printing mode in which the precoating liquid is used is set, and applies the precoating liquid to the paper. On the other hand, in a case where the second printing mode in which the precoating liquid is not used is set, the operation of the precoating device 14 is stopped.

Regarding the roller application type, in a case where the first printing mode is set, contact and separation between the application roller and the paper are repeated for each sheet of the paper, and a predetermined amount of the precoating liquid applied to the application roller is transferred to the paper. On the other hand, in a case where the second printing mode is set, the application roller is separated from the paper, and the application of the precoating liquid to the paper is not executed.

The printing control unit 106 sets a printing condition based on the command signal transmitted from the system control unit 100 and controls an operation of the printing device 16 based on the set printing condition. That is, the printing control unit 106 controls the jetting of the ink jet head 30 provided in the printing device 16. The printing conditions include a printing mode.

The printing control unit 106 comprises an image processing unit 110, a driving voltage generation unit 112, and a driving waveform setting unit 114. The image processing unit 110 executes color separation processing, color conversion processing, correction processing of each processing, and halftone processing on printing data to generate halftone data for each color.

The driving voltage generation unit 112 generates a driving voltage to be supplied to the ink jet head 30 of each color based on the halftone data for each color, and supplies the driving voltage to the ink jet head 30.

The driving voltage generation unit 112 generates a jetting timing signal indicating a jetting timing for each nozzle provided in the ink jet head 30 of each color based on the halftone data for each color, and supplies the jetting timing signal to the ink jet head 30. That is, the driving voltage generation unit 112 includes an electric circuit that outputs the driving voltage and an electric circuit that outputs the jetting timing signal.

The driving waveform setting unit 114 reads out the driving waveform stored in the driving waveform storage unit 122 according to the printing condition or the like, and sets the driving waveform to be applied to the driving voltage. The driving waveform setting unit 114 may have a function of adjusting the driving waveform.

The printing control unit 106 executes jetting correction of the ink jet head 30 on an abnormal nozzle specified based on the read data of the test pattern transmitted from the in-line sensor 34. Examples of the jetting correction include mask processing on the non-jetting nozzle and substitute jetting using a nozzle in the vicinity of the non-jetting nozzle with respect to the printing position of the non-jetting nozzle.

The in-line sensor control unit 107 sets a reading condition of the in-line sensor 34 based on the command signal transmitted from the system control unit 100, and controls the reading of the test pattern in which the in-line sensor 34 is used.

The in-line sensor control unit 107 acquires the read data of the test pattern transmitted from the in-line sensor 34. The printing system 10 specifies the abnormal nozzle based on the read data of the test pattern acquired via the in-line sensor control unit 107. Information on the abnormal nozzle is transmitted to the printing control unit 106.

The drying control unit 108 sets a treatment condition such as a drying strength in the drying treatment based on the command signal transmitted from the system control unit 100, and controls an operation of the drying device 18 based on the set treatment condition.

The inspection control unit 109 sets an inspection condition based on the command signal transmitted from the system control unit 100, and controls an operation of the inspection device 20 based on the set inspection condition. The inspection control unit 109 acquires an inspection result of the printed image representing the quality of the printed image from the inspection device 20.

The system control unit 100 sorts the printed image of a good quality and the printed image of a poor quality in the accumulation device 22 shown in FIG. 1 based on the inspection result of the printed image acquired from the inspection device 20.

### [Configuration Example of Hardware of Control Device Applied to Printing System]

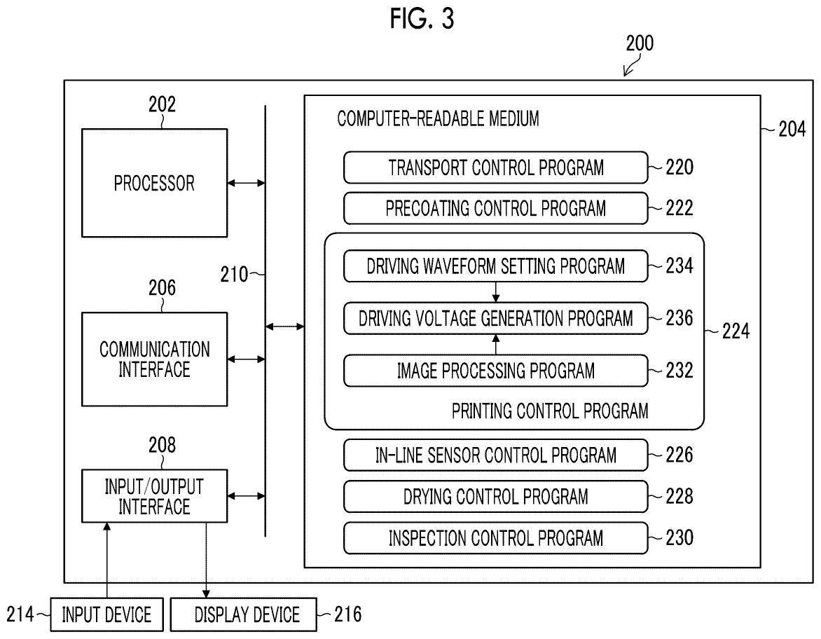

FIG. 3 is a block diagram schematically showing an example of a hardware configuration of the electric configuration shown in FIG. 2. A control device 200 provided in the printing system 10 comprises a processor 202, a computer-readable medium 204 that is a non-transitory tangible object, a communication interface 206, and an input/output interface 208.

A computer is applied as the control device 200. A form of the computer may be a server, a personal computer, a workstation, a tablet terminal, and the like.

The processor 202 includes a central processing unit (CPU). The processor 202 may include a graphics processing unit (GPU). The processor 202 is connected to the computer-readable medium 204, the communication interface 206, and the input/output interface 208 via a bus 210. An input device 214 and a display device 216 are connected to the bus 210 via the input/output interface 208.

The computer-readable medium 204 includes a memory that is a main memory, and a storage that is an auxiliary memory. A semiconductor memory, a hard disk apparatus, a solid state drive apparatus, and the like may be applied as the computer-readable medium 204. Any combination of a plurality of devices may be applied as the computer-readable medium 204.

It should be noted that the hard disk apparatus can be referred to as HDD that is an abbreviation for hard disk drive in English. The solid state drive apparatus can be referred to as SSD that is an abbreviation for solid state drive in English.

The control device 200 is connected to a network via the communication interface 206, and is communicably connected to an external device. A local area network (LAN) and the like may be applied as the network. It should be noted that the network is not shown.

The computer-readable medium 204 stores a transport control program 220, a precoating control program 222, a printing control program 224, an in-line sensor control program 226, a drying control program 228, and an inspection control program 230.

The transport control program 220 is applied to the transport control unit 102 shown in FIG. 2 to realize a transport function of the paper. The precoating control program 222 is applied to the precoating control unit 104 to realize an application function of the precoating liquid.

The printing control program 224 is applied to the printing control unit 106 to realize a printing function. The printing control program 224 includes an image processing program 232, a driving waveform setting program 234, and a driving voltage generation program 236.

The image processing program 232 is applied to the image processing unit 110 to realize an image processing function. The driving waveform setting program 234 is applied to the driving waveform setting unit 114 to realize a driving waveform setting function. The driving voltage generation program 236 is applied to the driving voltage generation unit 112 and cooperates with the image processing program 232 and the driving waveform setting program 234 to realize a driving voltage generation function.

The in-line sensor control program 226 is applied to the in-line sensor control unit 107 to realize a reading function of the in-line sensor 34. The drying control program 228 is applied to the drying control unit 108 to realize a drying function of the paper using the drying device 18. The inspection control program 230 is applied to the inspection control unit 109 to realize an inspection function of an image printed on paper using the inspection device 20.

Various programs stored in the computer-readable medium 204 include one or more instructions. The computer-readable medium 204 stores various types of data, various parameters, and the like. The memory 120 including the driving waveform storage unit 122 and the data storage unit 124 shown in FIG. 2 can be included in the computer-readable medium 204 shown in FIG. 3.

In the printing system 10, the processor 202 executes various programs stored in the computer-readable medium 204 to realize various functions in the printing system 10. It should be noted that the term “program” is synonymous with the term “software”.

The control device 200 executes data communication with the external device via the communication interface 206. Various standards such as universal serial bus (USB) may be applied to the communication interface 206. As a communication form of the communication interface 206, either wired communication or wireless communication may be applied.

The input device 214 and the display device 216 are connected to the control device 200 via the input/output interface 208. An input device such as a keyboard and a mouse is applied as the input device 214. The display device 216 displays various types of information applied to the control device 200.

A liquid crystal display, an organic EL display, a projector, and the like may be applied as the display device 216. Any combination of a plurality of devices can be applied as the display device 216. It should be noted that EL of the organic EL display is an abbreviation for electro-luminescence.

Here, examples of a hardware structure of the processor 202 include a CPU, a GPU, a programmable logic device (PLD), and an application specific integrated circuit (ASIC). The CPU is a general-purpose processor that acts as various functional units by executing a program. The GPU is a processor specialized in the image processing.

The PLD is a processor in which a configuration of an electric circuit can be changed after manufacturing the device. Examples of the PLD include a field programmable gate array (FPGA). The ASIC is a processor comprising a dedicated electric circuit specifically designed to execute specific processing.

One processing unit may be configured by one of these various processors or may be configured by two or more processors of the same type or different types. Examples of a combination of the various processors include a combination of one or more FPGAs and one or more CPUs, and a combination of one or more FPGAs and one or more GPUs. As another example of the combination of the various processors, there is a combination of one or more CPUs and one or more GPUs.

A plurality of functional units may be configured by using one processor. As an example in which the plurality of functional units are configured by using one processor, there is an aspect in which one processor is configured by applying a combination of one or more CPUs and software, such as system on a chip (SoC) represented by the computer, such as a client or a server, and this processor is made to act as the plurality of functional units.

As another example in which the plurality of functional units are configured by using one processor, there is an aspect in which a processor that realizes functions of the entire system including the plurality of functional units by using one IC chip is used. It should be noted that IC is an abbreviation for an integrated circuit.

As described above, various functional units are configured by using one or more of the various processors described above as the hardware structure. Further, the hardware structure of these various processors is, more specifically, an electric circuit (circuitry) in which circuit elements, such as semiconductor elements, are combined.

The computer-readable medium 204 may include semiconductor elements, such as a read only memory (ROM), a random access memory (RAM), and a solid state drive (SSD). The computer-readable medium 204 may include a magnetic storage medium such as a hard disk. The computer-readable medium 204 may be provided with a plurality of types of storage media.

### [Configuration Example of Ink Jet Head]

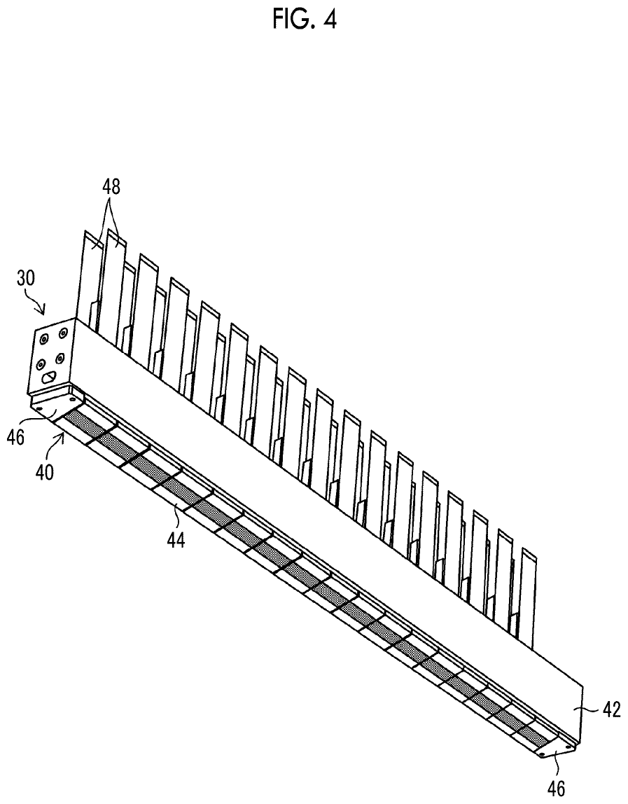

FIG. 4 is a perspective view showing a configuration example of the ink jet head. The ink jet head 30 shown in FIG. 4 has a structure in which a plurality of head modules 40 are connected in a line along a longitudinal direction of the ink jet head 30. The plurality of head modules 40 are integrated and supported by using a head frame 42.

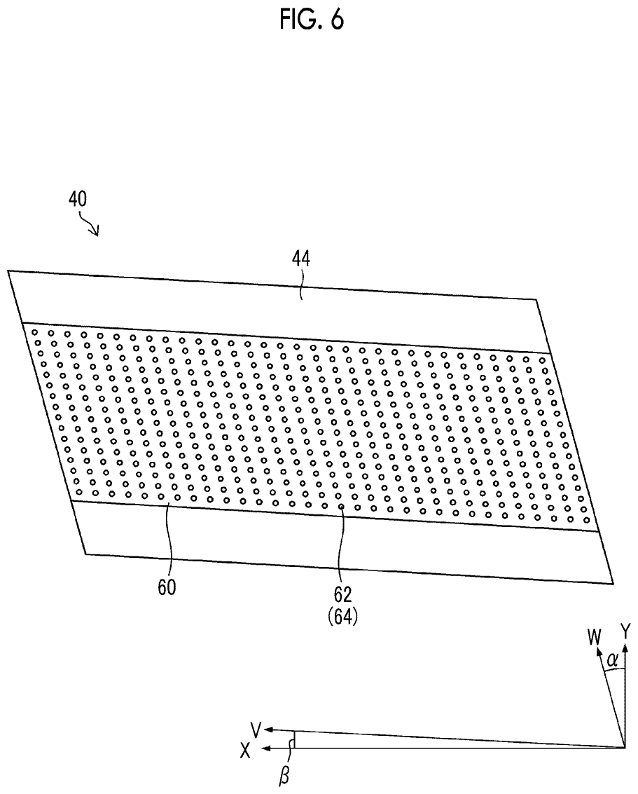

The ink jet head 30 is a line head in which a plurality of nozzles are disposed over a length corresponding to the entire width of the paper in the paper width direction. The nozzle is not shown in FIG. 4. The nozzle is shown with a reference numeral 62 in FIG. 6.

A planar shape of a nozzle surface 44 of the head module 40 is a parallelogram. Dummy plates 46 are attached to both ends of the head frame 42. The planar shape of the nozzle surface 44 of the ink jet head 30 is a rectangular shape as an entirety in which the head module 40 and the dummy plate 46 are combined.

A flexible substrate 48 is attached to the head module 40. The flexible substrate 48 is a wiring member that transmits a driving voltage supplied to the head module 40. One end of the flexible substrate 48 is electrically connected to the head module 40, and the other end thereof is electrically connected to a driving voltage supply circuit. The driving voltage supply circuit is not shown. The driving voltage supply circuit is a component of the driving voltage generation unit 112 shown in FIG. 2.

Each of the plurality of head modules 40 provided in the ink jet head 30 can be associated with a module number representing a position of the head module 40 in the order from the head module 40 disposed at one end of the ink jet head 30.

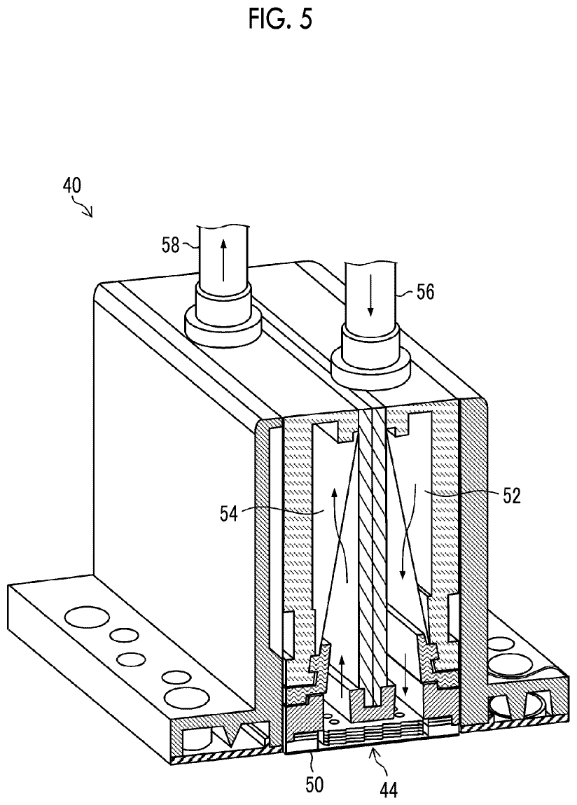

FIG. 5 is a perspective view of the head module and is a view including a partial cross-sectional view. The head module 40 has an ink supply unit including an ink supply chamber 52, an ink circulation chamber 54, and the like on an upper surface side in FIG. 5 which is opposite to the nozzle surface 44 of the nozzle plate 50.

The ink supply chamber 52 is connected to a buffer tank via a supply-side individual flow channel 56. The ink circulation chamber 54 is connected to the buffer tank via a recovery-side individual flow channel 58.

FIG. 6 is a plan view showing a nozzle disposition example of the ink jet head shown in FIG. 4. A central portion of the nozzle surface 44 of the head module 40 comprises a nozzle disposition portion 60 having a strip shape. The nozzle disposition portion 60 substantially functions as the nozzle surface 44.

A plurality of nozzles 62 are disposed in the nozzle disposition portion 60. The nozzle 62 includes a nozzle opening 64 formed on the nozzle surface 44. In the following description, the disposition of the nozzles 62 may also be interpreted as the disposition of the nozzle openings 64.

The head module 40 has a planar shape that is a parallelogram having an end surface on a long side along a V direction having a slope of an angle β with respect to the paper width direction shown by a reference numeral X and an end surface on a short side along a W direction having a slope of an angle α with respect to the paper transport direction shown by a reference numeral Y.

In the head module 40, the plurality of nozzles 62 are disposed in a matrix in a row direction along the V direction and a column direction along the W direction. The nozzles 62 may be disposed along a row direction along the paper width direction and a column direction obliquely intersecting the paper width direction.

In a case of the ink jet head 30 in which the plurality of nozzles 62 are disposed in a matrix, a projection nozzle line in which each nozzle 62 in the matrix disposition is projected along a nozzle line direction can be considered to be equivalent to one nozzle line in which the respective nozzles 62 are disposed at substantially equal intervals at a density that achieves the maximum recording resolution for the nozzle line direction. The projection nozzle line is a nozzle line in which each nozzle 62 in the matrix disposition is orthographically projected along the nozzle line direction.

The substantially equal interval means that droplet striking points that can be recorded in the printing device are substantially equal intervals. For example, a case where the intervals are slightly different in consideration of at least any one of a manufacturing error or movement of liquid droplets on the paper due to landing interference is also included in the concept of the equal interval. The projection nozzle line substantially corresponds to the nozzle line. In consideration of the projection nozzle line, each nozzle 62 can be associated with a nozzle number representing a nozzle position in the order of disposition of the projection nozzles arranged along the nozzle line direction.

It should be noted that, although FIG. 6 shows, as an example, the ink jet head 30 in which the plurality of nozzles are disposed in a matrix, one-line disposition may be applied to the plurality of nozzles, or zigzag disposition in two lines may be applied to the plurality of nozzles.

A substantial density of the nozzles 62 in the paper width direction corresponds to a printing resolution in the paper width direction. Examples of the printing resolution in the paper width direction include 1200 dots per inch. Dots per inch representing the number of dots per inch may be referred to as dpi using an abbreviation for dot per inch.

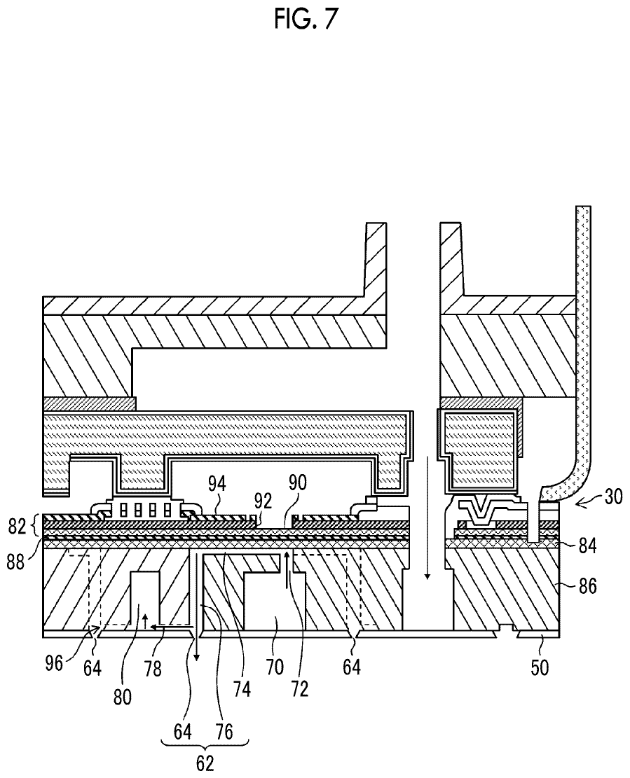

FIG. 7 is a cross-sectional view showing an internal structure of the head module. The head module 40 comprises an ink supply path 70, an individual supply path 72, a pressure chamber 74, a nozzle communication path 76, an individual circulation flow channel 78, a common circulation flow channel 80, a piezoelectric element 82, and a vibration plate 84.

The ink supply path 70, the individual supply path 72, the pressure chamber 74, the nozzle communication path 76, the individual circulation flow channel 78, and the common circulation flow channel 80 are formed in a flow channel structure 86. The nozzle 62 includes the nozzle opening 64 and the nozzle communication path 76. The nozzle communication path 76 is a flow channel constituting a jetting element, and corresponds to a flow channel communicating with the nozzle opening 64.

The individual supply path 72 is a flow channel that connects the pressure chamber 74 and the ink supply path 70. The nozzle communication path 76 is a flow channel that connects the pressure chamber 74 and the nozzle opening 64. The individual circulation flow channel 78 is a flow channel that connects the nozzle communication path 76 and the common circulation flow channel 80.

The vibration plate 84 is disposed on the flow channel structure 86. The piezoelectric element 82 is disposed on the vibration plate 84 via an adhesive layer 88. The piezoelectric element 82 has a laminated structure of a lower electrode 90, a piezoelectric layer 92, and an upper electrode 94. The lower electrode 90 may be referred to as a common electrode, and the upper electrode 94 may be referred to as an individual electrode.

The upper electrode 94 is an individual electrode that is patterned corresponding to a shape of each pressure chamber 74, and the piezoelectric element 82 is provided in each pressure chamber 74. The piezoelectric element 82 corresponds to an energy generation element constituting the jetting element.

The ink supply path 70 communicates with the ink supply chamber 52 shown in FIG. 5. The ink is supplied from the ink supply path 70 to the pressure chamber 74 via the individual supply path 72. The driving voltage is applied to the upper electrode 94 of the piezoelectric element 82 to be operated according to image data, and the piezoelectric element 82 and the vibration plate 84 are deformed to change a volume of the pressure chamber 74.

The head module 40 jets ink liquid droplets from the nozzle opening 64 via the nozzle communication path 76 in response to a pressure change accompanying the change in the volume of the pressure chamber 74. The image data can be referred to as printing data, printing source data, or the like.

The pressure chamber 74 corresponding to each of the nozzle openings 64 has a planar shape of a substantially square shape, an outlet port to the nozzle opening 64 is disposed at one of both corner portions on a diagonal line, and the individual supply path 72, which is an inlet port of the ink, is disposed at the other thereof. The shape of the pressure chamber is not limited to a square. The planar shape of the pressure chamber may be various forms such as a rectangle such as a rhombus and a quadrangle, a pentagon, a hexagon or other polygons, a circle, and an ellipse.

A circulation outlet 96 is formed in the nozzle communication path 76. The nozzle communication path 76 communicates with the individual circulation flow channel 78 via the circulation outlet 96. Among the inks held in the nozzle 62, an ink that is not used for jetting is recovered in the common circulation flow channel 80 via the individual circulation flow channel 78.

The common circulation flow channel 80 communicates with the ink circulation chamber 54 shown in FIG. 5. The ink is recovered in the common circulation flow channel 80 via the individual circulation flow channel 78. As a result, thickening of the ink held in the nozzle 62 during a non-jetting period is prevented.

FIG. 7 shows the piezoelectric element 82 having a structure that is individually separated corresponding to each of the plurality of nozzles 62. Of course, a structure may be applied in which the piezoelectric layer 92 is integrally formed with the plurality of nozzles 62, the individual electrodes are formed corresponding to each of the plurality of nozzles 62, and an active region is formed in each of the nozzles 62.

### [Flowchart of Printing Control Method According to First Embodiment]

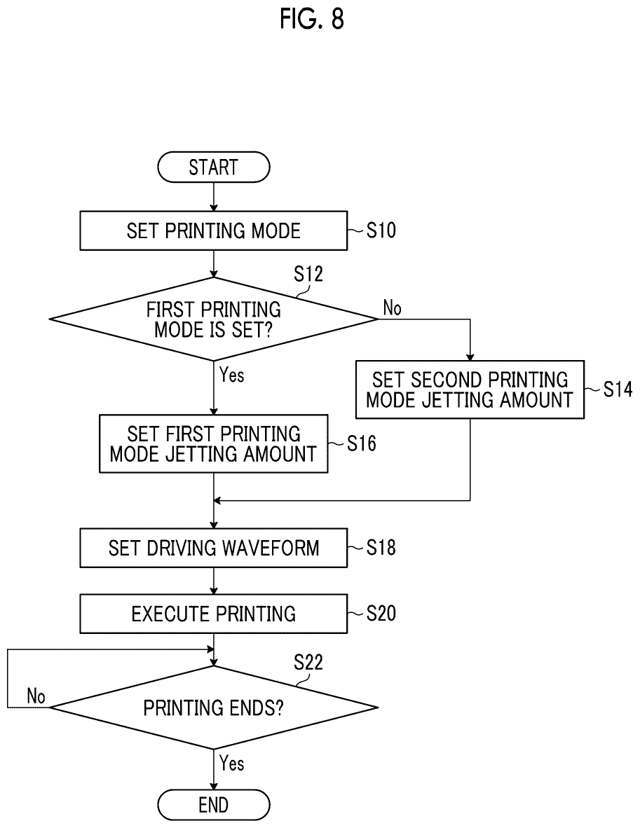

FIG. 8 is a flowchart showing a procedure of a printing control method according to the first embodiment. In a printing mode setting step S10, the printing mode setting unit 140 shown in FIG. 2 sets the first printing mode or the second printing mode. The printing mode setting unit 140 may acquire information on the printing mode input by the user by using the input device 214 shown in FIG. 3, and may set the printing mode based on the acquired information on the printing mode.

The printing mode setting unit 140 may set the first printing mode in a case where a single-sided printing mode of printing an image on only one surface of the paper is set, and may set the second printing mode in a case where a double-sided printing mode of printing an image on both sides of one surface and the other surface of the paper is set. In the printing mode setting step S10, in a case where the printing mode is set, the process proceeds to a printing mode determination step S12.

In the printing mode determination step S12, the driving waveform setting unit 114 determines whether the first printing mode is set or the second printing mode is set. In the printing mode determination step S12, in a case where the driving waveform setting unit 114 determines that the second printing mode is set, No determination is made. In a case of the No determination, the process proceeds to a second printing mode jetting amount setting step S14.

In the second printing mode jetting amount setting step S14, the driving waveform setting unit 114 sets a jetting amount of the one-component ink applied to the second printing mode. In a case where the jetting amount of the one-component ink is set in the second printing mode jetting amount setting step S14, the process proceeds to a driving waveform setting step S18. The one-component ink described in the embodiment is an example of a second ink that does not contain a component that reacts with the pretreatment liquid.

On the other hand, in the printing mode determination step S12, in a case where the driving waveform setting unit 114 determines that the first printing mode is set, Yes determination is made. In a case of the Yes determination, the process proceeds to a first printing mode jetting amount setting step S16.

In the first printing mode jetting amount setting step S16, the driving waveform setting unit 114 sets a jetting amount of the two-component ink applied to the first printing mode. In a case where the jetting amount of the two-component ink is set in the first printing mode jetting amount setting step S16, the process proceeds to a driving waveform setting step S18. The two-component ink described in the embodiment is an example of a first ink having a property of being thickened by reacting with the pretreatment liquid.

In the driving waveform setting step S18, the driving waveform setting unit 114 sets the driving waveform based on the ink jetting amount set in the second printing mode jetting amount setting step S14 or the ink jetting amount set in the first printing mode jetting amount setting step S16. In a case where the driving waveform is set in the driving waveform setting step S18, the process proceeds to a printing execution step S20.

In the printing execution step S20, the driving voltage generation unit 112 applies a dot size for each printing pixel and a jetting timing for each nozzle that are prescribed based on the printing data, and applies the driving waveform set in the driving waveform setting step S18 to supply the driving voltage to each nozzle to execute the printing. In a case where the printing is started in the printing execution step S20, the process proceeds to a printing end determination step S22.

In the printing end determination step S22, the printing control unit 106 determines whether or not a prescribed printing end condition is satisfied during the execution of printing. Examples of the prescribed printing end condition include end of a prescribed number of printed sheets, end of a prescribed printing job, and acquisition of a printing end instruction.

In the printing end determination step S22, in a case where the printing control unit 106 determines that the prescribed printing end condition is not satisfied, No determination is made. In a case of the No determination, the determination of the printing end condition is continued until Yes determination is made in the printing end determination step S22.

On the other hand, in the printing end determination step S22, in a case where the printing control unit 106 determines that the prescribed printing end condition is satisfied, Yes determination is made. In a case of the Yes determination, the printing control unit 106 executes prescribed printing end processing to end the printing.

### [Detailed Description of Setting of Printing Condition for Each Printing Mode]

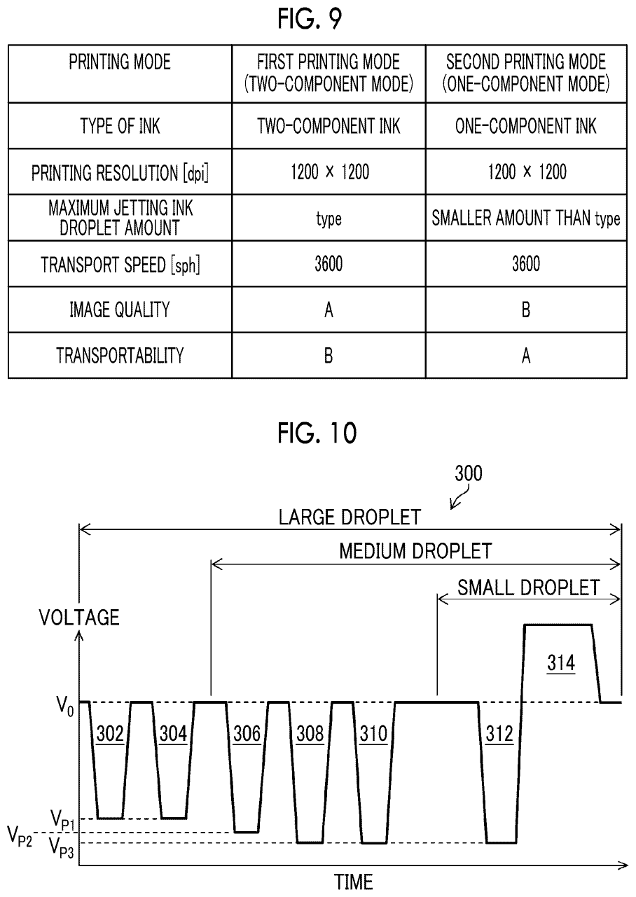

FIG. 9 is a table showing setting of a parameter for each printing mode applied to the printing system according to the first embodiment. The table shown in FIG. 9 includes an image quality evaluation and a transportability evaluation for each printing mode. “dpi” shown in the table of FIG. 9 is dots per inch as a unit of the printing resolution. In addition, “sph” is a unit of the transport speed and is sheets per hour, which represents the number of printed sheets per hour. “type” and “less than type” in a maximum jetting ink droplet amount field indicate that the ink jetting amount to be jetted from one nozzle in one jetting period is smaller in the second printing mode than in the first printing mode.

A and B described in an image quality field represent a relative difference in image quality. In an evaluation of the image quality, conditions that a resolution is 1200×1200 dots per inch and a transport speed is 3600 sheets per hour were applied.

The image quality evaluation A indicates that the image quality is good as compared with the image quality evaluation B. In addition, A and B described in a transportability field shown in the table of FIG. 9 represent a relative difference in transportability. The transportability evaluation A indicates that the transportability is good as compared with the transportability evaluation B.

### [Specific Example of Driving Waveform]

FIG. 10 is a schematic diagram representing a first driving waveform applied to the first printing mode. FIG. 10 schematically shows the driving waveform using a graph format. A horizontal axis of the graph shown in FIG. 10 represents a time in units of seconds. A vertical axis represents a voltage in units of volts. The voltage of the driving waveform is synonymous with an amplitude of the driving waveform.

V₀ represents a reference potential. The reference potential V₀ is a potential of a driving waveform that realizes a meniscus in a static state. Vₚ₁, Vₚ₂, and Vₚ₃ each represent a peak potential. The peak potential Vₚ₁, the peak potential Vₚ₂, and the peak potential Vₚ₃ may be collectively referred to as a peak potential Vₚ.

A first driving waveform 300 realizes an operation of the piezoelectric element that draws the meniscus in a static state into the inside of the nozzle and maintains a state in which the meniscus is drawn into the inside of the nozzle for a certain time, and realizes jetting of the ink by pushing out the ink from the nozzle.

The first driving waveform 300 includes a first pulse 302, a second pulse 304, a third pulse 306, a fourth pulse 308, a fifth pulse 310, and a sixth pulse 312 as a plurality of pulse waveforms. In addition, the first driving waveform 300 includes a static pulse 314 for stabilizing the meniscus.

The first driving waveform 300 realizes a jetting amount corresponding to each of three types of liquid droplet sizes, which are referred to as a large droplet, a medium droplet, and a small droplet. The large droplet has a larger jetting amount than the medium droplet and the small droplet. The medium droplet has a smaller jetting amount than the large droplet and a larger jetting amount than the small droplet. The small droplet has a smaller jetting amount than the large droplet and the medium droplet.

In a case where the small droplet is formed, the sixth pulse 312 is applied. In a case where the medium droplet is formed, the third pulse 306, the fourth pulse 308, the fifth pulse 310, and the sixth pulse 312 are applied. In a case where the large droplet is formed, all the pulses from the first pulse 302 to the sixth pulse 312 are applied. The static pulse 314 is applied to any of the large droplet, the medium droplet, and the small droplet.

That is, in a case where the small droplet is formed, an enable signal for prescribing the jetting timing for each nozzle selects the sixth pulse 312 and the static pulse 314. Similarly, in a case where the medium droplet is formed, the third pulse 306, the fourth pulse 308, the fifth pulse 310, the sixth pulse 312, and the static pulse 314 are selected. In a case where the large droplet is formed, the first pulse 302 to the static pulse 314 are selected.

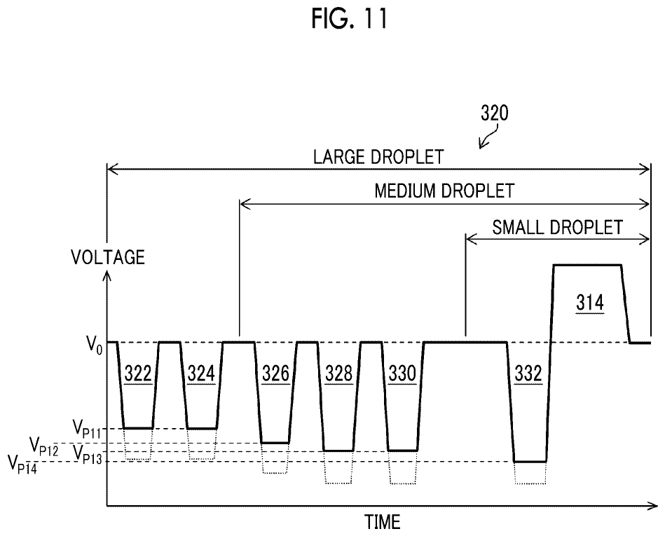

FIG. 11 is a schematic diagram showing a first example of a second driving waveform applied to the second printing mode. A second driving waveform 320 according to the first example includes an eleventh pulse 322, a twelfth pulse 324, a thirteenth pulse 326, a fourteenth pulse 328, a fifteenth pulse 330, a sixteenth pulse 332, and a static pulse 314.

The voltage of the eleventh pulse 322 from the reference potential V₀ to the peak potential Vₚ₁₁ is 25% smaller than the voltage of the first pulse 302 from the reference potential V₀ to the peak potential Vₚ₁ shown in FIG. 10. The voltage of the twelfth pulse 324 from the reference potential V₀ to the peak potential Vₚ₁₁ is 25% smaller than the voltage of the second pulse 304 from the reference potential V₀ to the peak potential Vₚ₁.

The voltage of the thirteenth pulse 326 from the reference potential V₀ to the peak potential Vₚ₁₂ is 25% smaller than the voltage of the third pulse 306 from the reference potential V₀ to the peak potential Vₚ₂. The voltage of the fourteenth pulse 328 from the reference potential V₀ to the peak potential Vₚ₁₃ is 25% smaller than the voltage of the fourth pulse 308 from the reference potential V₀ to the peak potential Vₚ₃.

The voltage of the fifteenth pulse 330 from the reference potential V₀ to the peak potential Vₚ₁₃ is 25% smaller than the voltage of the fifth pulse 310 from the reference potential V₀ to the peak potential Vₚ₃. The voltage of the sixteenth pulse 332 from the reference potential V₀ to the peak potential Vₚ₁₄ is 25% smaller than the voltage of the sixth pulse 312 from the reference potential V₀ to the peak potential Vₚ₃.

The selection of the pulses corresponding to the large droplet, the medium droplet, and the small droplet in the second driving waveform 320 is the same as that in the first driving waveform 300 shown in FIG. 10. In addition, the static pulse 314 in the second driving waveform 320 is the same as the static pulse 314 in the first driving waveform 300. In FIG. 11, each of the first pulse 302 to the sixth pulse 312 is shown by using a broken line.

In a case where the second driving waveform 320 shown in FIG. 11 is applied, the ink jetting amount is reduced by 25% for each of the large droplet, the medium droplet, and the small droplet as compared with a case where the first driving waveform 300 is applied. The above-described reduction ratio of the ink jetting amount can be calculated from an area ratio between the first driving waveform 300 shown in FIG. 10 and the second driving waveform 320 shown in FIG. 11. The reduction ratio of the ink jetting amount can be appropriately prescribed in a range in which the liquid droplet size is not changed.

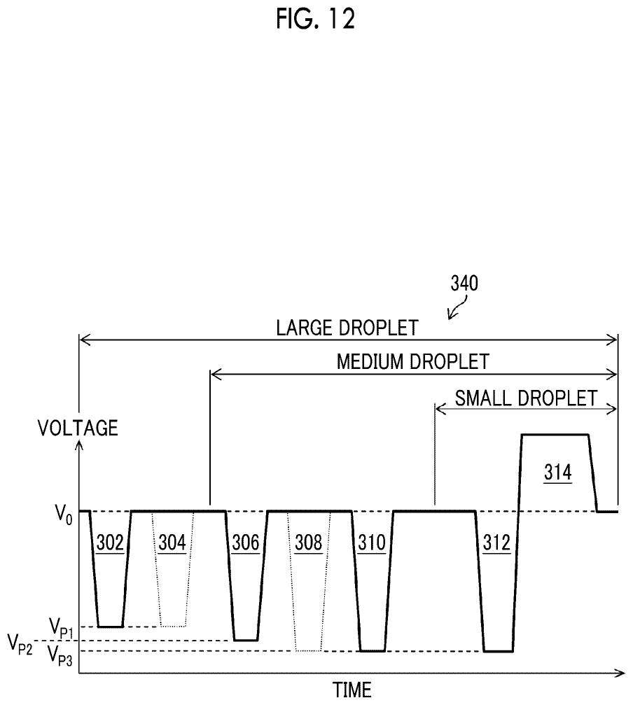

FIG. 12 is a schematic diagram showing a second example of the second driving waveform applied to the second printing mode. In the second driving waveform 340 according to the second example, the second pulse 304 and the fourth pulse 308 are missing as compared with the first driving waveform 300 shown in FIG. 10, and the number of pulses in a case where the medium droplet and the large droplet are formed is smaller than that in the first printing mode.

That is, in a case where the large droplet is formed, the first pulse 302, the third pulse 306, the fifth pulse 310, the sixth pulse 312, and the static pulse 314 are applied, and in a case where the medium droplet is formed, the third pulse 306, the fifth pulse 310, the sixth pulse 312, and the static pulse 314 are applied. In a case where the small droplet is formed, the sixth pulse 312 and the static pulse 314 are applied.

In a case where the second driving waveform 340 shown in FIG. 12 is applied, the ink jetting amount in a case where the large droplet is formed is reduced by approximately 33% and the ink jetting amount in a case where the medium droplet is formed is reduced by approximately 25% as compared with a case where the first driving waveform 300 is applied.

The ink jetting amount in a case where the second driving waveform 340 is applied and the small droplet is formed is the same as the ink jetting amount in a case where the first driving waveform 300 is applied and the small droplet is formed. Even in a case where the small droplet is formed by reducing the voltage of the sixth pulse 312 as in a case of the sixteenth pulse 332 shown in FIG. 11, the ink jetting amount may be reduced as compared with the first printing mode. In FIG. 12, the second pulse 304 and the fourth pulse 308 are shown by broken lines. The reduction in the number of pulses in the second driving waveform 340 can be appropriately prescribed within a range in which the liquid droplet size is not changed.

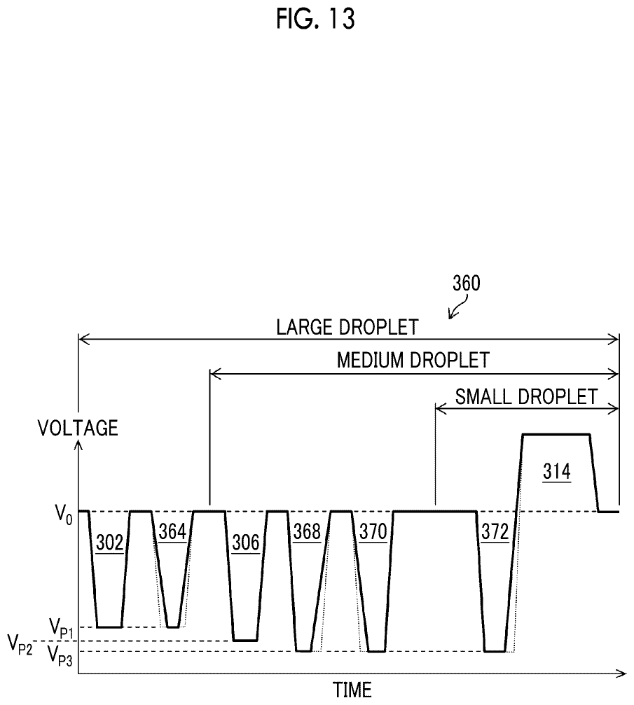

FIG. 13 is a schematic diagram showing a third example of the second driving waveform applied to the second printing mode. In a second driving waveform 360 according to the third example, a twenty-second pulse 364 is included instead of the second pulse 304, and a twenty-fourth pulse 368 is included instead of the fourth pulse 308, as compared with the first driving waveform 300 shown in FIG. 10. In addition, the second driving waveform 360 includes a twenty-fifth pulse 370 instead of the fifth pulse 310 and includes a twenty-sixth pulse 372 instead of the sixth pulse 312.

In the twenty-second pulse 364, a slope representing a change in the voltage from the reference potential V₀ to the peak potential Vₚ₁ per unit time is reduced. In the twenty-second pulse 364, the slope in a case of changing from the reference potential V₀ to the peak potential Vₚ₁ and the slope in a case of changing from the peak potential Vₚ₁ to the reference potential V₀ are smaller than those in the second pulse 304.

In the twenty-fourth pulse 368, the slope in a case of changing from the reference potential V₀ to the peak potential Vₚ₂ is the same as that in the fourth pulse 308, and the slope in a case of changing from the peak potential Vₚ₂ to the reference potential V₀ is smaller than that in the fourth pulse 308.

In the twenty-fifth pulse 370, the slope in a case of changing from the reference potential V₀ to the peak potential Vₚ₃ is smaller than that in the fifth pulse 310, and the slope in a case of changing from the peak potential Vₚ₃ to the reference potential V₀ is the same as that in the fifth pulse 310.

In the twenty-sixth pulse 372, the slope in a case of changing from the reference potential V₀ to the peak potential Vₚ₃ is the same as that in the sixth pulse 312, and the slope in a case of changing from the peak potential Vₚ₃ to the reference potential V₀ is smaller than that in the sixth pulse 312.

That is, in a case where the slope is reduced from the first pulse 302 to the sixth pulse 312 constituting the first driving waveform 300, at least one of the slope in a case of changing from the reference potential V₀ to the peak potential Vₚ or the slope in a case of changing from the peak potential Vₚ to the reference potential V₀ is reduced.

In a case where the second driving waveform 360 shown in FIG. 13 is applied, the ink jetting amount in a case where the large droplet is formed is reduced by approximately 20%, the ink jetting amount in a case where the medium droplet is formed is reduced by approximately 27%, and the ink jetting amount in a case where the small droplet is formed is reduced by approximately 17% as compared with a case where the first driving waveform 300 is applied. In FIG. 13, the second pulse 304, the fourth pulse 308, the fifth pulse 310, and the sixth pulse 312 are shown by broken lines. The change in the slope in the second driving waveform 360 can be appropriately prescribed in a range in which the liquid droplet size is not changed.

### [Application Example to Printing Control Device]

A printing control device may be configured by using some of the components of the printing system 10 shown in FIGS. 2 and 3. For example, by using some of the components of the printing system 10, a computer can be applied as hardware, and a printing control device comprising the system control unit 100, the printing control unit 106, the memory 120, the printing mode setting unit 140, and the like shown in FIG. 2 can be configured.

### [Operation and Effect of First Embodiment]

The printing system 10 and the printing control method according to the first embodiment can obtain the following operation and effect.

[1]

In the first printing mode in which the precoating liquid is used, the first driving waveform 300 is applied, and in the second printing mode in which the precoating liquid is not used, the second driving waveform 320 or the like is applied. In a case where the second driving waveform 320 is applied, the maximum jetting amount of the ink to be jetted from one nozzle in one jetting period is reduced as compared with a case where the first driving waveform 300 is applied.

As a result, the optimization of the ink jetting amount in the first printing mode and the second printing mode is realized. In addition, as a result of the optimization of the ink jetting amount, a certain quality of the printed image is ensured, which can contribute to cost reduction.

[2]

In the second driving waveform 320, a potential difference from the reference potential V₀ to the peak potential Vₚ is relatively reduced as compared with the first driving waveform 300. As a result, in a case where the second driving waveform 320 is applied, the maximum jetting amount of the ink to be jetted from one nozzle in one jetting period can be reduced as compared with a case where the first driving waveform 300 is applied.

[3]

In the second driving waveform 340, the second pulse 304 and the fourth pulse 308 constituting the first driving waveform 300 are missing, and the number of pulses smaller than that in the first driving waveform 300 is applied. As a result, in a case where the second driving waveform 340 is applied, the maximum jetting amount of the ink to be jetted from one nozzle in one jetting period can be reduced as compared with a case where the first driving waveform 300 is applied.

[4]

In the second driving waveform 360, a slope representing a change in the voltage between the reference potential V₀ and the peak potential Vₚ per unit time is reduced as compared with the first driving waveform 300. As a result, in a case where the second driving waveform 340 is applied, the maximum jetting amount of the ink to be jetted from one nozzle in one jetting period can be reduced as compared with a case where the first driving waveform 300 is applied.

[5]

In a case where a plurality of types of liquid droplet sizes are used as the liquid droplet size to be jetted from one nozzle in one jetting period, the jetting amount is reduced for the liquid droplet of each size in the second printing mode as compared with the first printing mode. As a result, the ink jetting amount is optimized for each liquid droplet size.

### [Configuration Example of Printing System According to Second Embodiment]

### [Problems]

A drying strength required for drying the paper on which the image is printed is different between the first printing mode in which the precoating liquid is used and the second printing mode in which the precoating liquid is not used. In a case where the first printing mode and the second printing mode are switched, it is necessary to execute switching of drying performance of the drying device without delay with respect to a timing at which the printing mode is switched.

In an image forming apparatus disclosed in JP4655697B, in the double-sided printing mode, a jetting amount of a treatment liquid onto a front surface is reduced as compared with a jetting amount of the treatment liquid onto a back surface, but the optimization of the drying strength is not made.

In the ink jet printing device described in JP2021-054623A, a cooling air volume in a case where the treatment liquid is applied is reduced as compared with a case of a thin coated paper to which the treatment liquid is applied. As a result, the ink jet printing device described in JP2021-054623A realizes the suppression of power consumption. However, in the ink jet printing device described in JP2021-054623A, deformation of the paper due to insufficient drying may cause an obstruction to paper transport.

In the printing system according to the second embodiment, an optimal drying process is realized in both the first printing mode in which the precoating liquid is used and the second printing mode in which the precoating liquid is not used.

### [Overview]

The printing system according to the second embodiment applies the same overall configuration as the printing system 10 according to the first embodiment shown in FIG. 1. In the printing system according to the second embodiment, switching of the drying performance is executed according to the printing mode in the drying device 18. The details thereof will be described below.

### [Electric Configuration of Printing System]

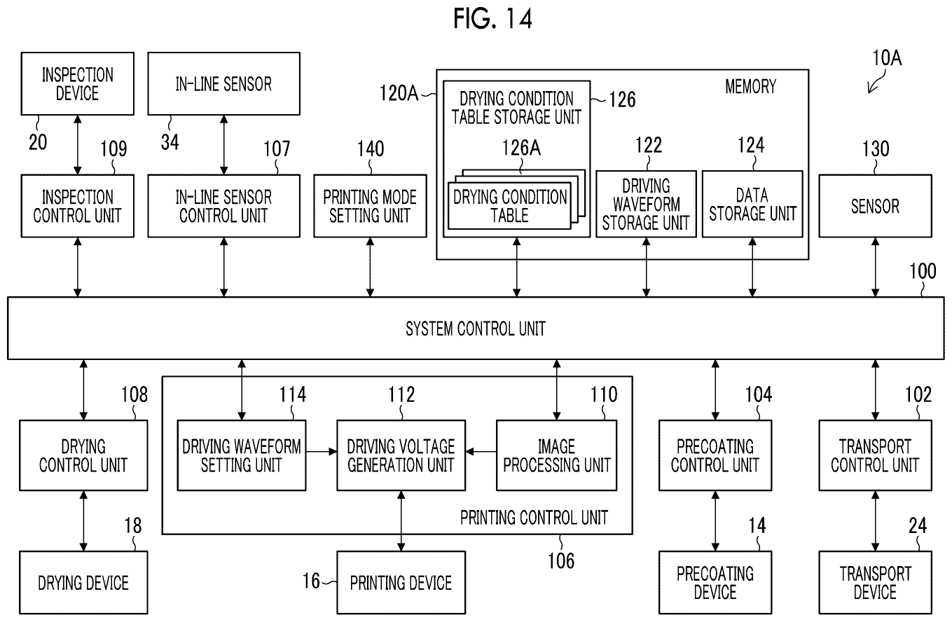

FIG. 14 is a functional block diagram showing an electric configuration of the printing system according to the second embodiment. In a printing system 10A shown in FIG. 14, a memory 120A is provided instead of the memory 120 in the printing system 10 shown in FIG. 2. The memory 120A includes a drying condition table storage unit 126 in which a plurality of drying condition tables 126A are stored.

In the second printing mode in which the precoating liquid is not used, a liquid amount applied to the paper is reduced by an application amount of the precoating liquid as compared with the first printing mode in which the precoating liquid is used. In addition, in the second printing mode, the ink jetting amount is reduced as compared with the first printing mode. As a result, in the second printing mode, energy required for drying the paper is reduced as compared with the first printing mode.

Therefore, in the printing system 10A, in a case where the second printing mode is set, a second drying strength lower than a first drying strength of the first printing mode is applied.

Specifically, a drying temperature applied to the second printing mode is lowered with respect to a drying temperature applied to the first printing mode. It has been found that, even in a case where the drying temperature applied to the second printing mode is lowered by 20° C. from the drying temperature applied to the first printing mode, an image printed on the paper has a sufficient image quality. For example, in a case where a drying temperature corresponding to the first drying strength is 100° C., a drying temperature corresponding to the second drying strength can be set to 80° C. That is, a decrease ratio of the second drying strength with respect to the first drying strength can be 20%.

In the second printing mode, since the drying temperature is lowered as compared with the first printing mode, the deformation occurring in the paper is suppressed, and the obstruction to the paper transport caused by the deformation of the paper is suppressed to improve the transportability of the paper. The printing conditions applied to each of the first printing mode and the second printing mode are that a transport speed of the paper is 3600 sheets per hour, and a printing resolution is 1200×1200 dots per inch. In addition, single-wafer paper is applied as the paper.

The switching of the drying conditions including the drying strength is made by switching the drying condition table 126A stored in the memory 120A. That is, the drying control unit 108 acquires information on the printing mode set using the printing mode setting unit 140, and in a case where the first printing mode is executed, reads out the drying condition table 126A for the first printing mode from the drying condition table storage unit 126. On the other hand, in a case where the second printing mode is executed, the drying control unit 108 reads out the drying condition table 126A for the second printing mode from the drying condition table storage unit 126.

The drying device 18 applies a drying strength according to a thickness of the paper. The drying control unit 108 reads out the drying condition table 126A in which drying conditions for each thickness of the paper are prescribed, from the memory 120A in accordance with the thickness of the paper.

The drying condition table 126A for the first printing mode described in the embodiment is an example of a first drying condition table. The drying condition table 126A for the second printing mode described in the embodiment is an example of a second drying condition table.

### [Configuration Example of Hardware of Control Device Applied to Printing System]

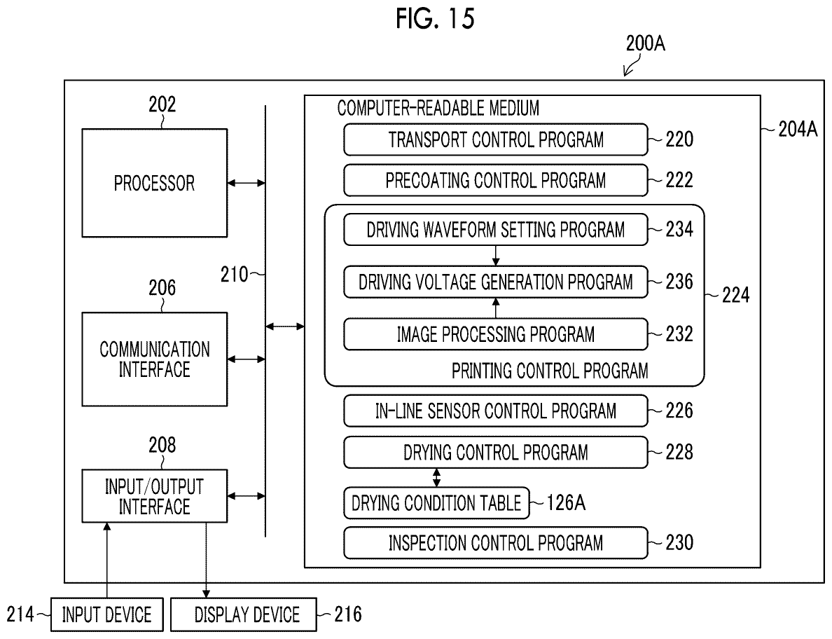

FIG. 15 is a block diagram schematically showing an example of a hardware configuration of the electric configuration shown in FIG. 14. A control device 200A shown in FIG. 15 comprises a computer-readable medium 204A in which the drying condition table 126A for each printing mode is stored.

The drying control program 228 reads out the drying condition table 126A according to the printing mode, and controls the operation of the drying device 18 shown in FIG. 14 by applying the drying condition prescribed in the drying condition table 126A to the drying device 18.

### [Flowchart of Printing Control Method According to Second Embodiment]

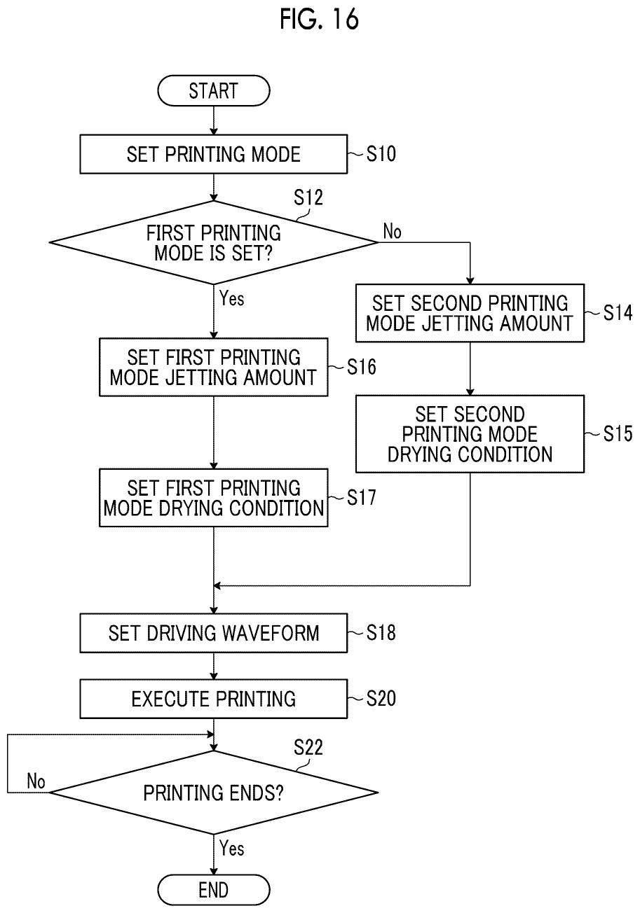

FIG. 16 is a flowchart showing a procedure of a printing control method according to the second embodiment. In the flowchart shown in FIG. 16, a second printing mode drying condition setting step S15 and a first printing mode drying condition setting step S17 are added to the flowchart shown in FIG. 8.

In the second jetting amount setting step S14, in a case where the jetting amount of the one-component ink applied to the second printing mode is set, the process proceeds to the second printing mode drying condition setting step S15. In the second printing mode drying condition setting step S15, the drying control unit 108 shown in FIG. 15 reads out the drying condition table 126A in which the drying strength applied to the second printing mode is prescribed, from the drying condition table storage unit 126. In a case where the drying condition is set in the second printing mode drying condition setting step S15, the process proceeds to the driving waveform setting step S18.

In addition, in the first printing mode jetting amount setting step S16, in a case where the jetting amount of the two-component ink applied to the first printing mode is set, the process proceeds to the first printing mode drying condition setting step S17. In the first printing mode drying condition setting step S17, the drying control unit 108 shown in FIG. 15 reads out the drying condition table 126A in which the drying strength applied to the first printing mode is prescribed, from the drying condition table storage unit 126. In a case where the drying condition is set in the first printing mode drying condition setting step S17, the process proceeds to the driving waveform setting step S18.

The second printing mode drying condition setting step S15 may be executed before the second printing mode jetting amount setting step S14, or may be executed after the driving waveform setting step S18 and before the printing execution step S20.

Similarly, the first printing mode drying condition setting step S17 may be executed before the first printing mode jetting amount setting step S16, or may be executed after the driving waveform setting step S18 and before the printing execution step S20.

### [Detailed Description of Setting of Printing Condition for Each Printing Mode]

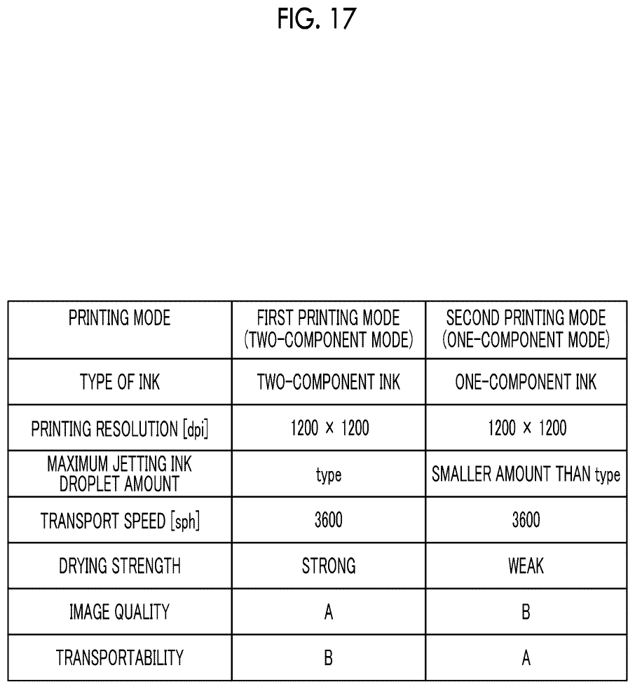

FIG. 17 is a table showing setting of a parameter for each printing mode applied to the printing system according to the second embodiment. In a table shown in FIG. 17, a drying strength field is added to the table shown in FIG. 9.

The drying strength field describes a relative relationship between the drying strength applied to the first printing mode and the drying strength applied to the second printing mode. That is, a relatively strong drying strength is applied to the first printing mode, and a relatively weak drying strength is applied to the second printing mode. In the present embodiment, 20% is illustrated as the decrease ratio of the second drying strength with respect to the first drying strength, but the decrease ratio of the drying strength is appropriately prescribed based on printing conditions such as the type of the paper and the type of the ink. For example, the decrease ratio of the drying strength may be more than 0% and 50% or less.

### [Operation and Effect of Second Embodiment]

The printing system 10A and the printing control method according to the second embodiment can obtain the following operation and effect.

[1]

In the second printing mode in which the precoating liquid is not used, a drying strength lower than that in the first printing mode in which the precoating liquid is used is applied, and a drying treatment suitable for each of the first printing mode and the second printing mode is executed. As a result, a prescribed drying state of the paper is realized, and preferred paper transport due to suppression of deformation of the paper is realized. In addition, a certain quality of the printed image can be ensured, which can contribute to cost reduction.

[2]

The switching between the drying strength in the first printing mode and the drying strength in the second printing mode is made by switching the drying condition table in which the drying strength is prescribed. As a result, it is possible to realize optimization of the drying treatment based on the prescribed drying strength.

### [Regarding Terms]

The term “printing device” is synonymous with terms, such as a printing machine, a printer, a typing device, an image recording device, an image forming device, an image output device, and a drawing device. An image is interpreted in a broad sense and also includes a color image, a monochrome image, a single color image, a gradation image, a uniform density image, and the like.

The term “printing” includes concepts of terms such as recording an image, forming an image, typing, drawing, and making a print. The term “device” can include a concept of a system.

The image is not limited to a photographic image, and is used as a collective term including a design, a text, a symbol, a line drawing, a mosaic pattern, a color-coding pattern, other various patterns, and an appropriate combination thereof. In addition, the term “image” may include meanings of an image signal and image data representing the image.

In the embodiments of the present invention described above, the components can be changed, added, or deleted as appropriate without departing from the spirit of the present invention. The present invention is not limited to the embodiments described above, and various modifications can be made by those having ordinary knowledge in the field within the technical idea of the present invention.

### EXPLANATION OF REFERENCES

10: printing system
10A: printing system
12: paper feeding device
14: precoating device
16: printing device
18: drying device
20: inspection device
22: accumulation device
24: transport device
30: ink jet head
30C: ink jet head
30K: ink jet head
30M: ink jet head
30Y: ink jet head
32: printing drum
34: in-line sensor
40: head module
42: head frame
44: nozzle surface
46: dummy plate
48: flexible substrate
50: nozzle plate
52: ink supply chamber
54: ink circulation chamber
56: supply-side individual flow channel
58: recovery-side individual flow channel
60: nozzle disposition portion
62: nozzle
64: nozzle opening
70: ink supply path
72: individual supply path
74: pressure chamber
76: nozzle communication path
78: individual circulation flow channel
80: common circulation flow channel
82: piezoelectric element
84: vibration plate
86: flow channel structure
88: adhesive layer
90: lower electrode
92: piezoelectric layer
94: upper electrode
96: circulation outlet
100: system control unit
102: transport control unit
104: precoating control unit
106: printing control unit
108: drying control unit
109: inspection control unit
110: image processing unit
112: driving voltage generation unit
114: driving waveform setting unit
120: memory
120A: memory
122: driving waveform storage unit
124: data storage unit
126: drying condition table storage unit
126A: drying condition table
130: sensor
140: printing mode setting unit
200: control device
200A: control device
202: processor
204: computer-readable medium
204A: computer-readable medium
206: communication interface
208: input/output interface
210: bus
214: input device
216: display device
220: transport control program
222: precoating control program
224: printing control program
226: in-line sensor control program
228: drying control program
230: inspection control program
232: image processing program
234: driving waveform setting program
236: driving voltage generation program
300: first driving waveform
302: first pulse
304: second pulse
306: third pulse
308: fourth pulse
310: fifth pulse
312: sixth pulse
314: static pulse
320: second driving waveform
322: eleventh pulse
324: twelfth pulse
326: thirteenth pulse
328: fourteenth pulse
330: fifteenth pulse
332: sixteenth pulse
340: second driving waveform
360: second driving waveform
364: twenty-second pulse
368: twenty-fourth pulse
370: twenty-fifth pulse
372: twenty-sixth pulse
each step from S10 to S22: each step of printing control method

What is claimed is:

1. A printing control device that controls a printing device including an ink jet head provided with one or more nozzles, the printing control device comprising:
one or more processors; and
one or more memories in which a program to be executed by the one or more processors is stored,
wherein the one or more processors execute the program to:
determine whether a first printing mode in which a pretreatment liquid that reacts with a liquid jetted from the ink jet head to relatively increase a viscosity of the liquid is applied to a medium or a second printing mode in which the pretreatment liquid is not applied to the medium is set;
set a first driving waveform as a driving waveform to be applied to the ink jet head in a case where it is determined that the first printing mode is set, and set a second driving waveform as the driving waveform to be applied to the ink jet head in a case where it is determined that the second printing mode is set; and
reduce a maximum liquid jetting amount to be jetted from one nozzle in one jetting period in a case where the second driving waveform is applied as compared with a case where the first driving waveform is applied,
the one or more processors selects, as liquid to be jetted from one nozzle, a large droplet, a medium droplet which has a smaller jetting amount than the large droplet or a small droplet which has a smaller jetting amount than the medium droplet,
the large droplet in the second driving waveform has a smaller jetting amount than the large droplet in the first driving waveform,
the medium droplet in the second driving waveform has a smaller jetting amount than the medium droplet in the first driving waveform, and
the small droplet in the second driving waveform has a smaller jetting amount than the small droplet in the first driving waveform.

2. A printing control device that controls a printing device including an ink jet head provided with one or more nozzles, the printing control device comprising:
one or more processors; and
one or more memories in which a program to be executed by the one or more processors is stored,
wherein the one or more processors execute the program to:
determine whether a first printing mode in which a pretreatment liquid that reacts with a liquid jetted from the ink jet head to relatively increase a viscosity of the liquid is applied to a medium or a second printing mode in which the pretreatment liquid is not applied to the medium is set;
set a first driving waveform as a driving waveform to be applied to the ink jet head in a case where it is determined that the first printing mode is set, and set a second driving waveform as the driving waveform to be applied to the ink jet head in a case where it is determined that the second printing mode is set; and
reduce a maximum liquid jetting amount to be jetted from one nozzle in one jetting period in a case where the second driving waveform is applied as compared with a case where the first driving waveform is applied,
the one or more processors selects, as liquid to be jetted from one nozzle, a large droplet, a medium droplet which has a smaller jetting amount than the large droplet or a small droplet which has a smaller jetting amount than the medium droplet,
the large droplet in the second driving waveform has a smaller jetting amount than the large droplet in the first driving waveform,
the medium droplet in the second driving waveform has a smaller jetting amount than the medium droplet in the first driving waveform, and
the small droplet in the second driving waveform has a jetting amount which is the same as a jetting amount of the small droplet in the first driving waveform.

3. The printing control device according to claim 1,
wherein the second driving waveform has a smaller amplitude than the first driving waveform.

4. The printing control device according to claim 2,
wherein the second driving waveform has a smaller amplitude than the first driving waveform.

5. The printing control device according to claim 1,
wherein each of the first driving waveform and the second driving waveform includes a plurality of pulse waveforms, and
the second driving waveform includes a smaller number of pulse waveforms than the first driving waveform.

6. The printing control device according to claim 2,
wherein each of the first driving waveform and the second driving waveform includes a plurality of pulse waveforms, and
the second driving waveform includes a smaller number of pulse waveforms than the first driving waveform.

7. The printing control device according to claim 1,
wherein the second driving waveform has a smaller amplitude change per unit time than the first driving waveform.

8. The printing control device according to claim 2,
wherein the second driving waveform has a smaller amplitude change per unit time than the first driving waveform.

9. The printing control device according to claim 1,
wherein the one or more processors apply the second printing mode in a case of applying the liquid to both sides of one surface and the other surface of the medium, and apply the first printing mode in a case of applying the liquid to only one surface of the medium.

10. The printing control device according to claim 2,
wherein the one or more processors apply the second printing mode in a case of applying the liquid to both sides of one surface and the other surface of the medium, and apply the first printing mode in a case of applying the liquid to only one surface of the medium.

11. The printing control device according to claim 1,
wherein, in a case of controlling a drying device that is provided in the printing device and that performs a drying treatment on the medium to which the liquid jetted from the ink jet head is applied, the one or more processors apply a first drying strength as a drying strength in a case where it is determined that the first printing mode is set, and apply a second drying strength as a drying strength in a case where it is determined that the second printing mode is set, and
the second drying strength is a drying strength lower than the first drying strength.

12. The printing control device according to claim 2,
wherein, in a case of controlling a drying device that is provided in the printing device and that performs a drying treatment on the medium to which the liquid jetted from the ink jet head is applied, the one or more processors apply a first drying strength as a drying strength in a case where it is determined that the first printing mode is set, and apply a second drying strength as a drying strength in a case where it is determined that the second printing mode is set, and
the second drying strength is a drying strength lower than the first drying strength.

13. The printing control device according to claim 11,
wherein the one or more processors read out a first drying condition table in which the first drying strength is prescribed in a case where the first printing mode is applied, and read out a second drying condition table in which the second drying strength is prescribed in a case where the second printing mode is applied.

14. The printing control device according to claim 12,
wherein the one or more processors read out a first drying condition table in which the first drying strength is prescribed in a case where the first printing mode is applied, and read out a second drying condition table in which the second drying strength is prescribed in a case where the second printing mode is applied.

15. A printing control method of controlling a printing device including an ink jet head provided with one or more nozzles, the printing control method comprising:
determining whether a first printing mode in which a pretreatment liquid that reacts with a liquid jetted from the ink jet head to relatively increase a viscosity of the liquid is applied to a medium or a second printing mode in which the pretreatment liquid is not applied to the medium is set;
setting a first driving waveform as a driving waveform to be applied to the ink jet head in a case where it is determined that the first printing mode is set, and setting a second driving waveform as the driving waveform to be applied to the ink jet head in a case where it is determined that the second printing mode is set; and
reducing a maximum liquid jetting amount to be jetted from one nozzle in one jetting period in a case where the second driving waveform is applied as compared with a case where the first driving waveform is applied,
wherein a large droplet, a medium droplet which has a smaller jetting amount than the large droplet or a small droplet which has a smaller jetting amount than the medium droplet, is selected as liquid to be jetted from one nozzle,
the large droplet in the second driving waveform has a smaller jetting amount than the large droplet in the first driving waveform,
the medium droplet in the second driving waveform has a smaller jetting amount than the medium droplet in the first driving waveform, and
the small droplet in the second driving waveform has a smaller jetting amount than the small droplet in the first driving waveform.

16. A printing control method of controlling a printing device including an ink jet head provided with one or more nozzles, the printing control method comprising:
determining whether a first printing mode in which a pretreatment liquid that reacts with a liquid jetted from the ink jet head to relatively increase a viscosity of the liquid is applied to a medium or a second printing mode in which the pretreatment liquid is not applied to the medium is set;
setting a first driving waveform as a driving waveform to be applied to the ink jet head in a case where it is determined that the first printing mode is set, and setting a second driving waveform as the driving waveform to be applied to the ink jet head in a case where it is determined that the second printing mode is set; and
reducing a maximum liquid jetting amount to be jetted from one nozzle in one jetting period in a case where the second driving waveform is applied as compared with a case where the first driving waveform is applied,
wherein a large droplet, a medium droplet which has a smaller jetting amount than the large droplet or a small droplet which has a smaller jetting amount than the medium droplet, is selected as liquid to be jetted from one nozzle,
the large droplet in the second driving waveform has a smaller jetting amount than the large droplet in the first driving waveform,
the medium droplet in the second driving waveform has a smaller jetting amount than the medium droplet in the first driving waveform, and
the small droplet in the second driving waveform has a jetting amount which is the same as a jetting amount of the small droplet in the first driving waveform.

17. A non-transitory, computer-readable tangible recording medium on which a program for causing, when read by a computer, the computer to execute the printing control method according to claim 15 is recorded.

18. A non-transitory, computer-readable tangible recording medium on which a program for causing, when read by a computer, the computer to execute the printing control method according to claim 16 is recorded.

19. A printing system comprising:
an ink jet head provided with one or more nozzles;
a pretreatment liquid applying device that applies a pretreatment liquid to a medium; and
the printing control device according to claim 1.

20. A printing system comprising:
an ink jet head provided with one or more nozzles;
a pretreatment liquid applying device that applies a pretreatment liquid to a medium; and
the printing control device according to claim 2.
